(19) United States
(12) Patent Application Publication
(10) Pub. No.: US 2016/0321632 A1
(43) Pub. Date: Nov. 3, 2016

(54) SYSTEMS AND METHODS FOR SECURE REMOTE DATA RETRIEVAL FOR KEY DUPLICATION

(71) Applicant: The Hillman Group, Inc., Cincinnati, OH (US)

(72) Inventors: Robert Clark Moore, Gilbert, AZ (US); Gary Edward Will, Gold Canyon, AZ (US)

(73) Assignee: The Hillman Group, Inc.

(21) Appl. No.: 15/140,091

(22) Filed: Apr. 27, 2016

Related U.S. Application Data
(60) Provisional application No. 62/153,702, filed on Apr. 28, 2015.

(51) Int. Cl. G06Q 20/18; G06Q 20/20; H04L 29/06; H04L 9/32; G06F 21/31; G06F 21/35

(52) U.S. Cl. CPC G06Q 20/18; G06F 21/31; G06F 21/35; H04L 63/0428; H04L 63/0492; H04L 9/321; G06Q 20/206; G06Q 20/202

(57) ABSTRACT

A system for storing key information for duplicating a key includes a kiosk comprising a key identification module. After identifying key blank and bitting pattern information for one or more master keys associated with a user, the kiosk receives a user request to store the identified key information on a remote device associated with the user. Upon verification of the user's identity, the kiosk may encrypt the identified key information, and transmit it to the remote device for storage. On a future visit, upon verification of the user's identity, a kiosk comprising a key identification module and a key cutting module may receive and decrypt the previously stored key information from the remote device. The kiosk may cut the key for the user via the key cutting module based on the previously stored key information.

### CROSS-REFERENCE TO RELATED APPLICATIONS

This application claims priority under 35 U.S.C. §119 to U.S. Provisional Application No. 62/153,702, filed on Apr. 28, 2015, which is expressly incorporated herein by reference in its entirety.

### FIELD

The present disclosure generally relates to key duplication systems and related methods, and more particularly, to systems and methods for enabling a user to retrieve saved key data stored remotely to recut a key that has previously been duplicated.

### BACKGROUND

Various systems of key duplication exist in the marketplace. A typical key duplication process has two aspects: identification of a proper key blank to be selected based on various characteristics of the master key; and cutting the key blank with the bitting pattern of the master key to successfully duplicate the key. Existing systems may automate some or all aspects of this process.

As systems become increasingly automated and customer demand for duplicated keys continues to exist in the marketplace, a rapid, streamlined process becomes essential. Customers demand not only an accurately cut duplicate key, but also that it be done as quickly as possible. Retail establishments that employ key duplication systems as part of their service offerings have an interest in increasing efficiency of their systems and of the employees who operate them and assist customers. Minimizing the time it takes to duplicate a key is important for success because it improves the customer experience and increases the revenue-generating potential of the key duplication system.

Customers are increasingly demanding the ability to have a key they desire to duplicate identified only once—including the determination of the bitting pattern. Thereafter, if the original key is lost or if additional copies are desired, the new key(s) may be quickly cut without having to repeat the identification and bitting pattern determination processes at the key duplication machine. Customers also desire geographic flexibility, wherein a new copy of a key may be quickly made at a different location than the original location where their key was identified and/or duplicated the first time.

Modern key duplication systems may attempt to solve this problem by creating data profiles containing data associated with cutting the key. One attempt at storing key data for later use is described in U.S. Pat. No. 8,626,331 (the '331 patent) issued to Marsh, et al. on Jan. 7, 2014. In particular, the '331 patent describes a system in which a customer specifies unique “identifying information” and “security information” associated with themselves. The user supplies an image of the key for which they wish to store data to a machine via the Internet. The machine may or may not be a machine equipped to actually duplicate keys. The machine determines geometric data associated with the customer's key, including information about an associated key blank to use in duplication of the key. The determined geometric data may further comprise bit heights of the customer's key.

The customer's key information is stored on a remote server. When the customer wishes to duplicate a key matching the key for which the information was submitted, the customer finds a key cutting machine associated with the same network as the machine where the information was submitted. The customer enters their “security information” into the machine. The machine verifies that the “security information” matches the information previously specified by the customer, retrieves the corresponding key geometric data, and may cut a key based on that data.

Although the key data storage system of the '331 patent may assist a customer in later duplicating a copy of a key based on previously stored data, the disclosed system is limited. That is, the key data storage system of the '331 patent has suboptimal levels of security and convenience. First, the system of the '331 patent requires information and security data specified by the customer themselves. While this feature may permit a customer to create, for example, a user name and password similar to ones they already use for other systems, this process is inherently less secure than a system where the security information is randomly generated each time the customer interacts with the key machine. The customer will likely choose a username and password combination that they use on other systems. While this may aid the customer in remembering the information, should one of those other systems get hacked, data associated with the customer's home, office, or car key may now be protected by the same password.

The system of the '331 patent is also inconvenient and inefficient. Its system requires submission of an image of the customer's key to the key machine via the Internet. Some customers may not have suitable means of producing such an image, or may not have a portable user device capable of transmitting such an image to the key machine. Any complications in the customer generating the key image, transmitting it to the system, and having the system identify the key from the image could result in failure of the process and customer frustration.

The disclosed system is directed to overcoming one or more of the problems set forth above and/or elsewhere in the prior art.

### SUMMARY

The present disclosure is directed to an improved key duplication system, and a related method. The advantages and purposes of the disclosed embodiments will be set forth in part in the description which follows, and in part will be apparent from the description, or may be learned by practice of the disclosed embodiments. The advantages and purposes of the disclosed embodiments will be realized and attained by the elements and combinations particularly pointed out in the appended claims.

In accordance with the disclosed embodiments, a system is disclosed. The system includes one or more kiosks, each kiosk comprising one or more processor devices, and a key identification module. The one or more processor devices associated with the one or more kiosks may be configured to receive a request from a user to store key information determined by the key identification module. Further, the one or more processor devices may be configured to verify the identity of the user, and encrypt the key information. The one or more processor devices may also be configured to transmit the encrypted key information and information associated with the identity of the user to a remote device associated with the user.

In another aspect, a system is disclosed. The system includes one or more kiosks, each kiosk comprising one or more processor devices, a key identification module and a key cutting module. The one or more processor devices associated with the one or more kiosks may be configured to receive a request from a user to retrieve previously stored key information associated with the user. Further, the one or more processor devices may be configured to verify the identity of the user, and receive a communication from the remote device associated with the user comprising the previously stored key information in an encrypted form. The one or more processor devices may also be configured to decrypt the previously stored key information. The one or more processor devices may be configured to determine, via the key identification module, a key blank associated with the decrypted key information. Additionally, the one or more processor devices may be configured to cut, via the key cutting module, the key blank based at least on the decrypted key information, and provide the cut key blank to the user.

In yet another aspect, a method for storing key data via one or more kiosks comprising one or more processor devices, and a key identification module is disclosed. The method comprises receiving a request from a user to store key information determined by the key identification module. Additionally, the method comprises verifying the identity of the user and encrypting the key information. The method further comprises transmitting the encrypted key information and information associated with the identity of the user to a remote device associated with the user.

In still another aspect, a method for retrieving key data via one or more kiosks comprising one or more processor devices, a key identification module and a key cutting module is disclosed. The method comprises receiving a request from a user to retrieve previously stored key information associated with the user. The method further comprises verifying the identity of the user, and receiving a communication from a remote device associated with the user comprising the previously stored key information in an encrypted form. Also, the method comprises decrypting the previously stored key information. Additionally, the method comprises determining, via the key identification module, a key blank associated with the decrypted key information. The method includes cutting, via the key cutting module, the key blank based at least on the decrypted key information, and providing the cut key blank to the user.

Additional objects and advantages of the disclosed embodiments will be set forth in part in the description which follows, and in part will be apparent from the description, or may be learned by practice of the embodiments. The objects and advantages of the disclosed embodiments will be realized and attained by the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 is a diagrammatic illustration of an exemplary kiosk consistent with disclosed embodiments.

FIG. 2 is a diagrammatic illustration of an exemplary system environment consistent with disclosed embodiments.

FIG. 3 is a flowchart of an exemplary user key data storage process, consistent with embodiments disclosed herein.

FIG. 4 is a flowchart of an exemplary user key data retrieval process, consistent with embodiments disclosed herein.

FIG. 5 is a diagrammatic illustration of an exemplary system environment consistent with disclosed embodiments.

FIG. 6 is a flowchart of an exemplary user key data storage process, consistent with embodiments disclosed herein.

FIG. 7 is a flowchart of an exemplary user key data retrieval process, consistent with embodiments disclosed herein.

FIG. 8 is a flowchart of an exemplary user key data storage process, consistent with embodiments disclosed herein.

FIG. 9 is a flowchart of an exemplary user key data retrieval process, consistent with embodiments disclosed herein.

FIG. 10 is a diagrammatic illustration of an exemplary system environment consistent with disclosed embodiments.

FIG. 11 is a flowchart of an exemplary user key data storage process, consistent with embodiments disclosed herein.

FIG. 12 is a flowchart of an exemplary user key data storage process, consistent with embodiments disclosed herein.

FIG. 13 is a flowchart of an exemplary user key data retrieval process, consistent with embodiments disclosed herein.

FIG. 14 is a flowchart of an exemplary user key data retrieval process, consistent with embodiments disclosed herein.

FIG. 15 is a diagrammatic illustration of an exemplary system environment consistent with disclosed embodiments.

FIG. 16 is a flowchart of an exemplary user key data storage process, consistent with embodiments disclosed herein.

FIG. 17 is a flowchart of an exemplary user key data retrieval process, consistent with embodiments disclosed herein.

### DETAILED DESCRIPTION

Reference will now be made in detail to various embodiments, examples of which are illustrated in the accompanying drawings. Wherever possible, the same reference numbers will be used throughout the drawings to refer to the same or like parts.

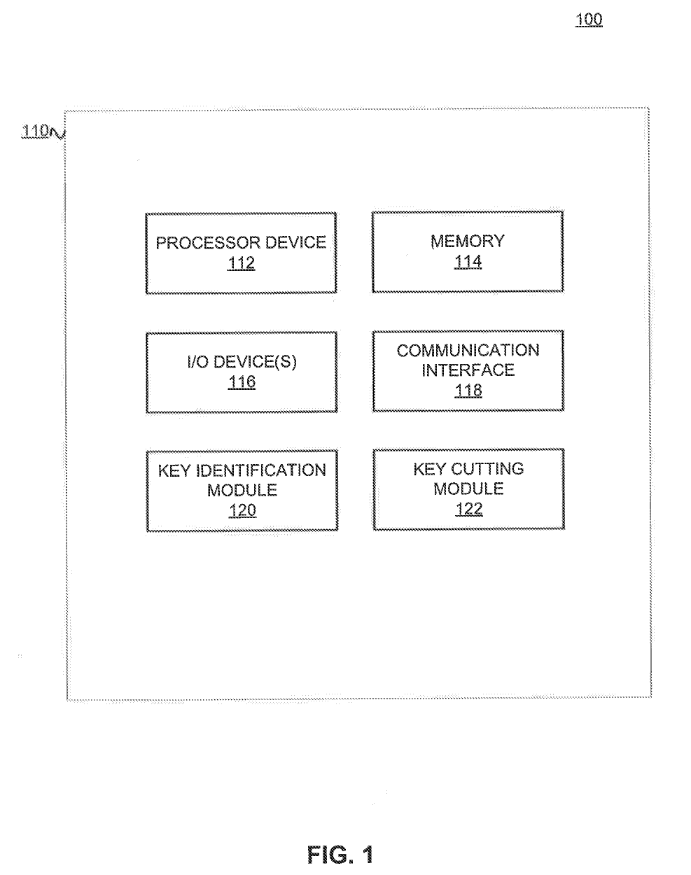

FIG. 1 illustrates a diagrammatic view of a key identification and/or duplication machine 110. Machine 110 may be a kiosk, and will be referred to throughout this specification as a “key duplication machine,” however, it is understood that machine 110 may be configured as a kiosk with more or fewer modules than are depicted in FIG. 1. Key duplication machine 110 may comprise various components to assist with relevant tasks, such as identifying a user's master key, determining data associated with the key, storing the data, and cutting keys either in real time or based on the previously stored data. For example, in the example illustrated in FIG. 1, key duplication machine 110 includes a processor device 112, a memory 114, input-output (I/O) devices 116, communications port 118, a key identification module 120, and a key cutting module 122. In other embodiments, other modules may be present, or modules may be omitted. For example, in some embodiments, key duplication machine 110 may be configured as a kiosk that does not contain a key cutting module 122.

Processor device 112 may be configured to execute software instructions to perform aspects of the disclosed embodiments. Processor device 112 may include one or more known processing devices, such as a microprocessor. For any given machine consistent with the disclosed embodiments, processor device 112 is not limited to any type of processor(s) or processor devices configured for any other system component. For example, within a network of key duplication kiosks, different kiosks within the network may be configured with different processor devices 112.

Memory 114 may include one or more storage devices configured to store instructions used by processor device 112 to perform functions related to disclosed embodiments. For example, memory 114 may be configured with one or more software instructions that may perform one or more operations when executed by processor 112. The disclosed embodiments are not limited to separate programs or computers configured to perform dedicated tasks. For example, memory 114 may include a single program that performs the functions of the disclosed embodiments, or may include multiple such programs. Memory 114 may also store data reflective of any type of information in any format that systems consistent with the disclosed embodiments may use to perform operations consistent with the disclosed embodiments.

Memory 114 may be volatile or non-volatile, magnetic, semiconductor, tape, optical, removable, nonremovable, or any other type of storage device or tangible computer-readable medium, including flash memory or other temporary memory devices. Memory 114 may comprise two or more memory devices distributed over a local or wide area network, or may be a single memory device. In certain embodiments, memory 114 may include database systems, such as database storage devices, and one or more database processing devices configured to receive instructions to access, process, and send information stored in the storage devices.

Key duplication machine 110 may contain a computing system (not shown), which may further comprise one or more processor devices 112 and one or more memory devices 114. The one or more processor devices 112 may be associated with control elements of machine 110 that position and operate the various components. As discussed above, the memory devices 114 may store programs and instructions, or may contain databases. Key duplication machine 110 may store information or data generated and/or used by other system components in the memory devices 114. Machine 110's computer system may also include one or more additional components that provide communications to other entities via known methods, such as telephonic means or computing systems, including the Internet.

I/O device(s) 116 may be one or more devices configured to allow information to be inputted, received, and/or transmitted by key duplication machine 110. I/O devices 116 may include one or more digital and/or analog communication devices that allow user input and/or may communicate information to the user. As non-limiting examples, I/O devices 116 may include one or more virtual or physical keyboards, user interfaces, touchscreens, speakers, microphones, or the like.

Communication interface 118 may include one or more communication components, such as wired Internet, DSL, cellular, WiFi, Bluetooth transceivers, near-field communication (NFC) components, or any other wireless transceivers or communication equipment. Communication interface 118 may be configured to package and send user commands or input across a network to remote systems or servers. Based on these commands and/or input, the remote system or server may return content or information to be displayed to the user. This additional content or information may be received from the remote system or server via communication interface 118. Processor device 112 may access and use information received via communication interface 118.

Key identification module 120 may contain machine-based systems or devices permitting key duplication machine 110 to identify a received user's master key and/or a proper key blank associated with the received master key in an automated fashion. In some embodiments, the machine-based system may comprise a machine vision-based system as is known in the art. The machine vision based system may comprise one or more light sources. In some embodiments, the light source(s) may output visible light. In other embodiments, the light source(s) may output infrared, near-infrared, or ultraviolet light. The machine vision based system may further comprise one or more digital cameras, which may be configured to acquire a visual image of the received master key. Additionally or alternatively, the machine-based systems or devices may comprise one or more laser scanners, which may be configured to scan the blade of the received master key. Key identification module 120 may compare one or more captured electronic representations of the received master key to information associated with a set of known key blanks to identify a key blank that matches the master key. Key identification module 120 may also capture the bitting pattern of the master key for eventual duplication into the identified matching key blank. Key identification module 120 may further communicate with other system components to store and later verify information, such as the captured bitting pattern or information about associated key blanks. In these embodiments, key identification module 120 may enable a user to rapidly retrieve this information and duplicate a key at a different location than the location where that information was initially gathered.

Key cutting module 122 may contain various devices and systems as are known in the art that are configured to cut a key blank identified by key identification module 120. Key cutting module 122 may also contain various alignment systems and devices for aligning and positioning a key blank for the cutting process. These devices, whose operation will be described in more detail below, may comprise pins, clamps, springs, or other related devices and mechanisms to facilitate alignment of the key blank in both lateral and longitudinal space.

Key cutting module 122 may further comprise one or more key cutter(s). In some embodiments, the associated key cutters may comprise one or more cutting wheels. In other embodiments, the key cutters may comprise one or more milling devices. In some embodiments, the cutters may comprise a combination of one or more cutting wheels and one or more milling devices.

In some embodiments, key cutting module 122 may comprise an electronic trace device. The trace device may be configured to access stored or acquired bitting pattern information from the memory devices, and cut a key blank in accordance with that information. As used herein, the term “electronic trace” is intended to broadly encompass key cutting functionality that does not rely on mechanical tracing of a master key. For example, an electronic trace device may duplicate an image of the master key bitting pattern. As another example, the device may, through a software algorithm, enhance the bitting pattern image to account for wear and conform more accurately to an OEM specification. In alternative embodiments, key cutting module 122 may comprise a mechanical tracing device.

As used herein, “module” is not used in a manner requiring a completely separate modular arrangement. Rather, “module” is used more generally to refer to the components necessary to provide the required functionality. The key cutting and key identification modules may be stand-alone structures capable of being operated individually or they may share common features such as supports, housing, etc. Moreover, a single user interface and processor, including all required software and hardware, may be utilized.

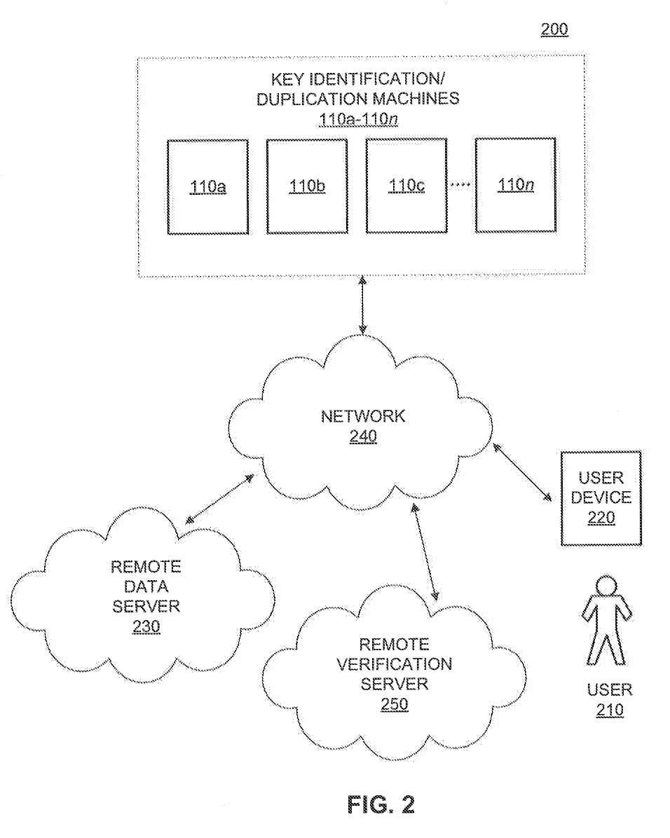

The above-identified functionality allows for identifying and duplicating a master key, either immediately at the same location or in the future, at the same or a different location. FIG. 2 illustrates an exemplary system 200 consistent with disclosed embodiments. In one aspect, system environment 200 may include multiple integrated key duplication machines 110a-110n. Each of key duplication machines 100a-110n may be substantially as described above.

User 210 may represent a customer or potential customer of a retail establishment. In alternative embodiments, user 210 may represent an employee of the retail establishment. User 210 may be untrained or have limited training in aspects of key duplication.

User device(s) 220 may include one or more processors configured to execute software instructions stored in memory, such as memory included in user device 220. User device 220 may include software executable by a processor to perform Internet-related communication and content presentation processes. For instance, user device 220 may execute software that generates and displays interfaces and/or content on a presentation device included in, or connected to, user device 220, or on one of key duplication machines 110a-110n via a particular machine's I/O device(s) 116. User device 220 may be a mobile device that executes mobile device applications and/or mobile device communication software that allows user device 220 to communicate with other system components over network 240. The disclosed embodiments are not limited to any particular configuration of user device 220.

Remote data server 230 may be a computer-based system including computer system components, such as one or more servers, desktop computers, workstations, tablets, hand held computing devices, memory devices, and/or internal network(s) connecting the components. In one embodiment, remote data server 230 may be a server that includes one or more processor(s), memory devices, and interface components configured to provide a cloud-based service. As used in this disclosure, services, processes, or applications that are “cloud-based” refer to scalable, distributed execution of one or more software processes over a network using real or virtual server hardware. Remote data server 230 may be a single server or a distributed computer system including multiple servers or computers that interoperate to perform one or more of the processes and functionalities associated with the disclosed embodiments.

In some embodiments, remote data server 230 may be a server that is associated with an institution that is also associated with key duplication machines 110a-110n. The institution may be, for example, a corporation, a merchant, a financial institution, or any other entity that provides services to customers. The institution may manage remote data server 230 such that remote data server 230 may be used to store data associated with customers and with keys associated with each such customer. In alternative embodiments, remote data server 230 may be hosted and managed by an entity other than an institution that is also associated with key duplication machines 110a-110n, such as a network service provider, internet service provider, telecommunications firm, etc.

The various components of system environment 200 may be commonly linked to a network 240 for purposes of communication and workflow distribution among the components. Network 240 may be any type of network that facilitates communications and data transfer, such as, for example, a Local Area Network (LAN), or a Wide Area Network (WAN), such as the Internet. Network 240 may be a single network or a combination of networks. Further, network 240 may comprise a single type of network or a combination of different types of networks, such as the Internet and public exchange networks for wireline and/or wireless communications. Network 240 may also comprise private networks for wireline and/or wireless communications. For example, a merchant or retailer (not shown in system environment 200) may provide access to the Internet via private networks not accessible by members of the general public. Network 240 may utilize cloud computing technologies that are known in the marketplace. One skilled in the art would recognize that network 240 is not limited to the above examples and that system 200 may implement and incorporate any type of network that allows the entities (and others not shown) included in FIG. 2 to exchange data and information.

Remote verification server 250 may be a computer-based system including computer system components, such as one or more servers, desktop computers, workstations, tablets, hand held computing devices, memory devices, and/or internal network(s) connecting the components. In one embodiment, remote verification server 250 may be a server that includes one or more processor(s), memory devices, and interface components configured to provide a cloud-based service. Remote verification server 250 may be a single server or a distributed computer system including multiple servers or computers that interoperate to perform one or more of the processes and functionalities associated with the disclosed embodiments. In some embodiments, remote verification server 250 may be the same server as remote data server 230, may share one or more architectural components, or may be managed by the same entity. In other embodiments, remote data server 230 and remote verification server 250 may be completely independent servers, and may be managed by different entities.

Although FIG. 2 describes a certain number of entities and processing/computing components within system environment 200, any number or combination of components may be implemented without departing from the scope of the disclosed embodiments. For example, in some embodiments more than one remote data server 230 or remote verification server 250 may be implemented. One skilled in the art will appreciate that the entities as described are not limited to their discrete descriptions above. Further, within system environment 200 the computing and processing devices and software executed by these components may be integrated into a local or distributed system. For example, the internal memory 114 of each of key duplication machines 110a-110n may be configured to store software instructions that when executed by the computing system may perform one or more functions relating to the combined components in a manner consistent with the disclosed embodiments.

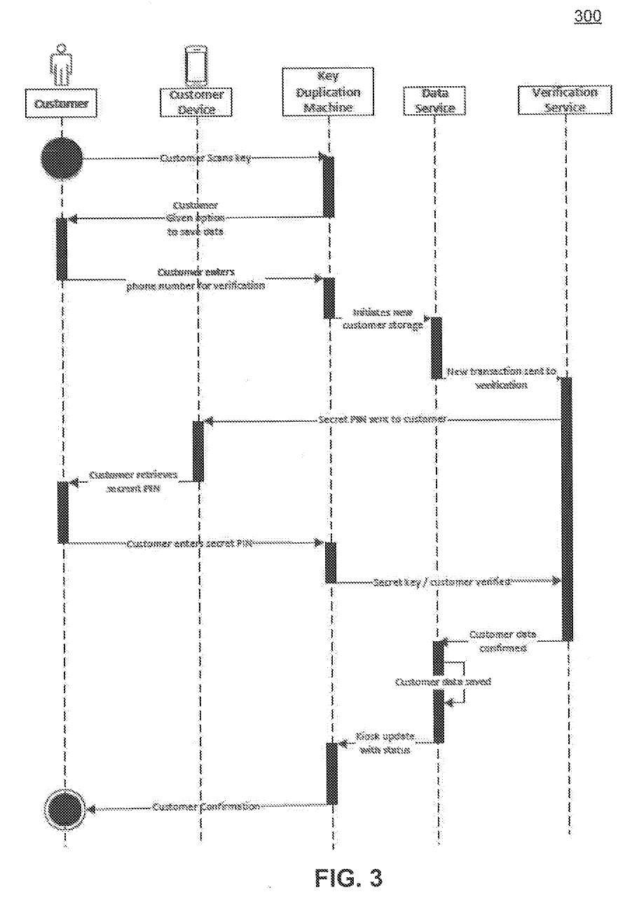

Exemplary operation of the disclosed systems and devices will now be described. FIG. 3 is a flowchart of an exemplary key data storage process 300, consistent with example embodiments disclosed herein. FIG. 3 will be described in connection with the components described above illustrated in FIG. 2 as being associated with system environment 200, but it is understood that other configurations are possible.

In one embodiment, a user 210 may approach any particular key duplication machine from among key duplication machines 110a-110n seeking to duplicate a master key and/or to save data associated with such a key for future duplications. User 210 may insert the master key into a dedicated receptacle within key duplication machine 110 for identification.

Key duplication machine 110 may determine a key blank corresponding to the received first master key using the machine-based devices housed within key identification module 120 described above. In some embodiments, key identification module 120 may determine the proper key blank by capturing an image, using a machine vision-based system. In these embodiments, module 120 may capture the image as a digital image using a camera. In other embodiments, an image may be captured using a laser scanner. These examples are not intended to be limiting, and a skilled artisan may contemplate various means of determining the proper key blank corresponding to the inserted master key.

Key duplication machine 110 may be further configured to determine the bitting pattern of the inserted master key of user 210. The bitting pattern may comprise, for example, the cuts in the key blade, or may include notches, depressions, or other such features on one or both edges of the key blade. Alternatively, the bitting pattern may comprise cuts on the broad side of the blade itself, such as those created by a milling machine. Key identification module 120 may determine the bitting pattern of user 210's master key using similar machine-based systems as described previously. In some embodiments, key duplication machine 110 may store the determined key blank information and bitting pattern in a database or memory device included in its computer system, such as memory 114. Alternatively, the bitting pattern information may be stored as a captured image, such that an exact notch pattern may be subsequently discerned by a key cutting machine or module.

Key duplication machine 110 may optionally proceed to cut the determined bitting pattern of the first master key into a key blank via one or more key cutters. In some embodiments, the key blank to be cut may be supplied manually by a user. In other embodiments, the proper key blank may be supplied automatically, such as from a magazine or other such storage compartment containing a plurality of key blanks. Prior to commencing cutting of the key blank, key duplication machine 110 may align the first key blank using a key alignment system or other features to ensure proper orientation of the first key blank for cutting. Elements of the alignment system may be integrated with the key cutter(s), or may be situated independently within key cutting module 122. When the key blank to be cut is introduced into the alignment system (either manually or automatically), the system may guide the blank into the proper lateral position using a series of guide rails, grooves, or other such physical features. The alignment system may further comprise spring-loaded mechanisms that prevent improper insertion and/or provide any necessary alignment.

The alignment system may further employ one or more methods for longitudinally aligning a key blank. For example, the alignment system may contain a tip stop apparatus that engages the tip of the key blank, halting any further longitudinal motion. In other embodiments, the alignment system may contain one or more features that contact the shoulder of the blank. After aligning the key blank in the X and Y directions, the alignment system may secure the position of the key blank using clamps, pins, or other such devices.

Once the alignment process is complete, the key cutter(s) may be translated laterally and longitudinally to cut a bitting pattern into the key blank corresponding to the analyzed bitting pattern of the inserted master key. In some embodiments, the key cutter(s) may move in unison in a given direction. In some embodiments, the key cutter(s) may move independently of one another in a given direction. Depending on the nature of the bitting pattern of the inserted master key, the key cutter(s) may cut one or both sides of the blade of key blank. If the bitting pattern of the master key requires cutting of both sides of the key blank, the key cutter(s) may cut both sides simultaneously, or may cut one side at a time. Alternatively, the cutter(s) may cut one side then engage elements of the alignment system to flip the key blank to cut the other side, or may prompt user 210 to manually do so. If the bitting pattern of the master key requires only one side of the key blank blade be cut, only one key cutter may be employed. In some embodiments, the key cutter(s) may be a milling head and the cutting operation may comprise milling a pattern into the blade of the key blank to match that identified in association with the master key.

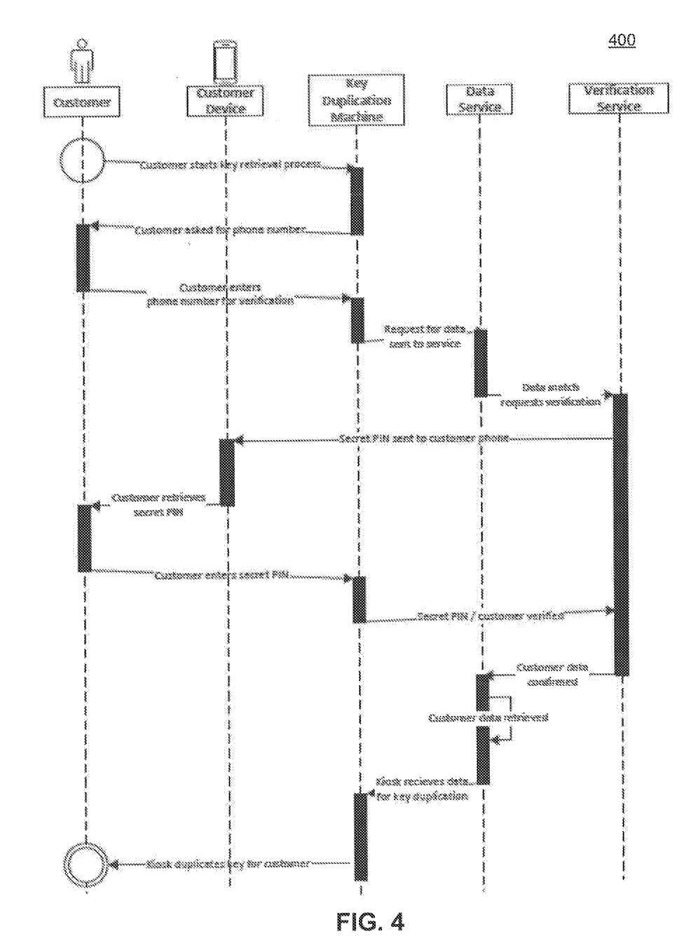

Key cutting module 122 may determine the proper bitting pattern to cut into the key blank in a variety of ways. Computing system elements of key duplication machine 110 (such as processor device 112) associated with key cutting module 122 may access stored bitting pattern information acquired by key identification module 120, as will be described in further detail below in association with FIG. 4. In some embodiments, the stored information may comprise a numeric code readable by the key cutting module that generates a known bitting pattern. Alternatively, key cutting module 122 may comprise an electronic tracing device that may cut the key blank according to stored information identifying the bitting pattern of the master key.

At any time during the above-described process, user 210 may be asked by key duplication machine 110 (such as via a user interface or touchscreen associated with I/O devices 116) if they wish to store the key data determined by key identification module 120. If user 210 opts to save the data, key duplication machine 110 may prompt the user for information that may be utilized to identify user 210. This information may include, but not be limited to, a telephone number associated with user 210 or a user device 220, an IP (Internet Protocol) address associated with user 210 or a user device 220, a MAC (media access control) address associated with user 210 or a user device 220, or any other identification specific to user 210, including but not limited to a unique identifier assigned to user 210 by an entity associated with key duplication machine 110, remote data server 230, or remote data server 250.

Upon receiving the identification information via I/O devices 116, key duplication machine 110 may initiate a data storage process. Via network 240, key duplication machine 110 may send a request to remote data server 230 seeking to initiate a new user data storage transaction.

After initiating the storage transaction, remote data server 230 may send a request to remote verification server 250 to verify user 210's identity. Remote verification server 250 may receive this request, and via one or more integrated processor devices, may generate a first secure code, or personal identification number (PIN). The code may be generated based on a random number generator, or by other known methods.

Via network 240, remote verification server 250 may transmit a communication to user 210 to be received via user device 220. In some embodiments, the communication may be sent to the telephone number or device address associated with user device 220 previously input into key duplication machine 110 by user 210. The communication is optimally transmitted within a period of several seconds up to several minutes from the time that user 210 indicated via key duplication machine 110 that they wished to store the determined key data.

In these embodiments, user 210 may receive the transmitted communication from remote verification server 250 via user device 220. The communication, comprising the first PIN, may be sent via SMS, text messaging, email, social media, or other such methods known to one of skill in the art. For security purposes, the communication transmitted by remote verification server 250 may include instructions intended for user 210. These instructions may include, for example, directions for how to securely confirm receipt of the first PIN.

In some embodiments, the instructions may prompt user 210 to enter the received first PIN into a user interface displayed on an I/O device 116 of key duplication machine 110. If user 210 wishes to continue with the data storage process at that time, user 210 may proceed to submit the first PIN to key duplication machine 110 for verification. Alternatively, if user 210 declines to proceed, the first PIN may not be submitted. In these alternative embodiments, system 200 (via remote data server 230 and/or remote verification server 250) may be configured to set a time within which the first PIN may expire. The configured expiration time may be on the order of minutes, hours, days, weeks, etc. The first PIN may be configured to expire for security reasons and to keep the data storage process within the full control of user 210. Should the first PIN expire, user 210 may initiate the data storage process again upon a future visit to a key duplication machine 110a-110n.

If user 210 does choose to proceed, and enters a PIN into key duplication machine 110, key duplication machine 110, via communication interface 118, may transmit the entered PIN to remote verification server 250 via network 240. Remote verification server 250 may receive the transmitted PIN, and may compare it to the first PIN previously transmitted to user device 220. If the PIN received from key duplication machine 110 does not match the transmitted first PIN, remote verification server 250 may be configured to not save the key data via remote data server 230, and may transmit a communication to that effect to key duplication machine 110. Key duplication machine 110 may receive the message via communication interface 118, and may be configured to display a message to user 210 via I/O device 116 that the PIN entered by user 210 was incorrect. Alternatively, system 200 may be configured such that remote verification server 250 transmits the “incorrect PIN” communication directly to user 210 via user device 220.

If the PIN received does match the transmitted first PIN, remote verification server 250 may confirm user 210's identity and the key data associated with user 210. Remote verification server 250 may transmit a communication to remote data server 230 indicating that user 210 has been verified and confirmed. This communication may be sent to remote data server 230 in the form of instructions executable by one or more processor devices associated with remote data server 230. Remote data server 230, via the processor device(s), may execute the instructions to store the key data within its associated memory devices and/or cloud storage platforms and devices. After successfully storing the data, remote data server 230 may transmit a communication to that effect to key duplication machine 110. Key duplication machine 110 may receive the message via communication interface 118, and may be configured to display a message to user 210 via I/O device 116 that the PIN entered by user 210 was correct and that data storage was successful. Alternatively, system 200 may be configured such that remote data server 230 transmits the “correct PIN/data stored” communication directly to user 210 via user device 220.

FIG. 4 is a flowchart of an exemplary key data retrieval process 400, consistent with example embodiments disclosed herein. FIG. 4 will be described in connection with the components described above illustrated in FIG. 2 as being associated with system environment 200, but it is understood that other configurations are possible.

In one embodiment, a user 210 may approach any particular key duplication machine from among key duplication machines 110a-110n seeking to duplicate a master key and/or to retrieve stored data associated with such a key from a past such duplication.

Via I/O devices 116, user 210 may interact with a key duplication machine 110. At any time during the interaction process, user 210 may be asked by key duplication machine 110 (such as via a user interface associated with I/O devices 116) if they wish to retrieve previously-stored key data. If user 210 opts to retrieve the data, key duplication machine 110 may prompt the user for information that may be utilized to identify user 210. This information may include, but not be limited to, a telephone number associated with user 210 or a user device 220, an IP (Internet Protocol) address associated with user 210 or a user device 220, a MAC (media access control) address associated with user 210 or a user device 220, or any other identification specific to user 210, including but not limited to a unique identifier assigned to user 210 by an entity associated with key duplication machine 110, remote data server 230, or remote data server 250.

Upon receiving the identification information via I/O devices 116, key duplication machine 110 may initiate the data retrieval process. Via network 240, key duplication machine 110 may send a request to remote data server 230 seeking to download stored key data associated with user 210 and/or user device 220.

After initiating a new retrieval transaction, remote data server 230 may send a request to remote verification server 250 to verify user 210's identity. Remote verification server 250 may receive this request, and via one or more integrated processor devices, may determine whether the identification information submitted by user 210 and transmitted via key duplication machine 110 matches that previously submitted by any other user. If the data does not match any previous identification information, remote verification server 250 may transmit a communication to key duplication machine 110 indicating that the user was not found within the server. Via I/O devices 116, key duplication machine 110 may inform user 210 that their information was not found, and may invite user 210 to attempt to submit the identification information a second time.

If the submitted identification information does match a previously-recognized user 210, remote verification server 250 may generate a second secure code, or personal identification number (PIN). The code may be generated based on a random number generator, or by other known methods. In some embodiments, the second PIN is different than the first PIN. In alternative embodiments, the second PIN may be the same as the first PIN.

Via network 240, remote verification server 250 may transmit a communication to user 210 to be received via user device 220. In some embodiments, the communication may be sent to the telephone number or device address associated with user device 220 previously input into key duplication machine 110 by user 210. The communication is optimally transmitted within a period of several seconds up to several minutes from the time that user 210 indicated via key duplication machine 110 that they wished to retrieve the previously-stored key data.

In these embodiments, user 210 may receive the transmitted communication from remote verification server 250 via user device 220. The communication, comprising the second PIN, may be sent via SMS, text messaging, email, social media, or other such methods known to one of skill in the art. For security purposes, the communication transmitted by remote verification server 250 may include instructions intended for user 210. These instructions may include, for example, directions for how to securely confirm receipt of the second PIN.

In some embodiments, the instructions may prompt user 210 to enter the received second PIN into a user interface displayed on an I/O device 116 of key duplication machine 110. If user 210 wishes to continue with the data retrieval process at that time, user 210 may proceed to submit the second PIN to key duplication machine 110 for verification. Alternatively, if user 210 declines to proceed, the second PIN may not be submitted. In these alternative embodiments, system 200 (via remote data server 230 and/or remote verification server 250) may be configured to set a time within which the second PIN may expire. The configured expiration time may be on the order of minutes, hours, days, weeks, etc. The second PIN may be configured to expire for security reasons and to keep the data storage process within the full control of user 210. Should the second PIN expire, user 210 may initiate the data storage process again upon a future visit to a key duplication machine 110a-110n.

If user 210 does choose to proceed, and enters a PIN into key duplication machine 110, key duplication machine 110, via communication interface 118, may transmit the entered PIN to remote verification server 250 via network 240. Remote verification server 250 may receive the transmitted PIN, and may compare it to the second PIN previously transmitted to user device 220. If the PIN received from key duplication machine 110 does not match the transmitted second PIN, remote verification server 250 may be configured to not retrieve any stored key data via remote data server 230, and may transmit a communication to that effect to key duplication machine 110. Key duplication machine 110 may receive the message via communication interface 118, and may be configured to display a message to user 210 via I/O device 116 that the pin entered by user 210 was incorrect. Alternatively, system 200 may be configured such that remote verification server 250 transmits the “incorrect PIN” communication directly to user 210 via user device 220.

If the PIN received does match the transmitted first PIN, remote verification server 250 may confirm user 210's identity and/or the key data associated with user 210. Remote verification server 250 may transmit a communication to remote data server 230 indicating that user 210 has been verified and confirmed. This communication may be sent to remote data server 230 in the form of instructions executable by one or more processor devices associated with remote data server 230. Remote data server 230, via the processor device(s), may execute the instructions to retrieve stored key data associated with user 210, and may convert the data into a form readable by a key duplication machine 110. After successfully retrieving the data, remote data server 230 may transmit a communication to that effect to key duplication machine 110. Key duplication machine 110 may receive the message via communication interface 118, and may be configured to display a message to user 210 via I/O device 116 that the pin entered by user 210 was correct and that data retrieval was successful. Alternatively, system 200 may be configured such that remote data server 230 transmits the “correct PIN/data retrieved” communication directly to user 210 via user device 220.

In these embodiments, remote data server 230 may transmit the stored key data associated with user 210 to key duplication machine 110. Key duplication machine 110 may be configured to receive the stored key data via communication interface 118, and via processor device 112 and key cutting module 122, may duplicate a key for user 210 based on the stored and retrieved key data. The key duplication process may proceed substantially as described above. Upon completion of the cutting of the key, key duplication machine 110 may provide the duplicated key to user 210.

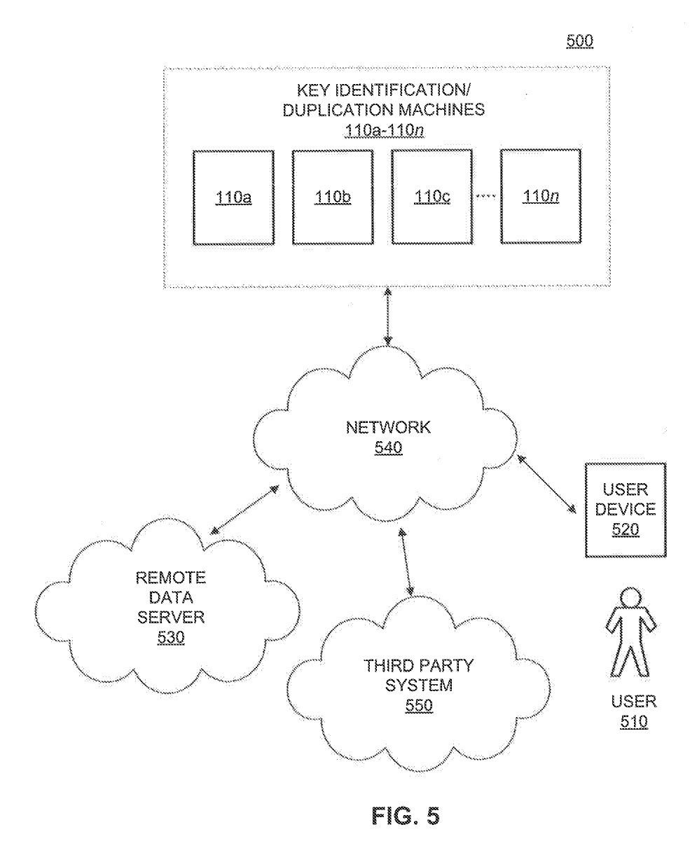

FIG. 5 illustrates an exemplary system 500 consistent with disclosed embodiments. In one aspect, system environment 500 may include multiple integrated key duplication machines 110a-110n. Each of key duplication machines 110a-110n may be substantially as described above.

User 510 may represent a customer or potential customer of a retail establishment. In alternative embodiments, user 510 may represent an employee of the retail establishment. User 510 may be untrained or have limited training in aspects of key duplication. In some embodiments, user 510 may be associated with one or more profiles, accounts, or other such presence on a network-accessible entity, such as a website, a social network, or any third party-controlled data hosted on a remote server.

User device(s) 520 may include one or more processors configured to execute software instructions stored in memory, such as memory included in user device 520. User device 520 may include software executable by a processor to perform Internet-related communication and content presentation processes. For instance, user device 520 may execute software that generates and displays interfaces and/or content on a presentation device included in, or connected to, user device 520, or on one of key duplication machines 110a-110n via a particular machine's I/O device(s) 116. User device 520 may be a mobile device that executes mobile device applications and/or mobile device communication software that allows user device 520 to communicate with other system components over network 540, for example, third party system 550. The disclosed embodiments are not limited to any particular configuration of user device 520.

Remote data server 530 may be a computer-based system including computer system components, such as one or more servers, desktop computers, workstations, tablets, hand held computing devices, memory devices, and/or internal network(s) connecting the components. In one embodiment, remote data server 530 may be a server that includes one or more processor(s), memory devices, and interface components configured to provide a cloud-based service. As used in this disclosure, services, processes, or applications that are “cloud-based” refer to scalable, distributed execution of one or more software processes over a network using real or virtual server hardware. Remote data server 530 may be a single server or a distributed computer system including multiple servers or computers that interoperate to perform one or more of the processes and functionalities associated with the disclosed embodiments.

In some embodiments, remote data server 530 may be a server that is associated with an institution that is also associated with key duplication machines 110a-110n. The institution may be, for example, a corporation, a merchant, a financial institution, or any other entity that provides services to customers. The institution may manage remote data server 530 such that remote data server 530 may be used to store data associated with customers and with keys associated with each such customer. In alternative embodiments, remote data server 530 may be hosted and managed by an entity other than an institution that is also associated with key duplication machines 110a-110n, such as a network service provider, internet service provider, telecommunications firm, etc.

The various components of system environment 500 may be commonly linked to a network 540 for purposes of communication and workflow distribution among the components. Network 540 may be any type of network that facilitates communications and data transfer, such as, for example, a Local Area Network (LAN), or a Wide Area Network (WAN), such as the Internet. Network 540 may be a single network or a combination of networks. Further, network 540 may comprise a single type of network or a combination of different types of networks, such as the Internet and public exchange networks for wireline and/or wireless communications. Network 540 may also comprise private networks for wireline and/or wireless communications. For example, a merchant or retailer (not shown in system environment 500) may provide access to the Internet via private networks not accessible by members of the general public. Network 540 may utilize cloud computing technologies that are known in the marketplace. One skilled in the art would recognize that network 540 is not limited to the above examples and that system 500 may implement and incorporate any type of network that allows the entities (and others not shown) included in FIG. 5 to exchange data and information.

Third party system 550 may be a computer-based system including computer system components, such as one or more servers, desktop computers, workstations, tablets, hand held computing devices, memory devices, and/or internal network(s) connecting the components. Third party system 550 may be associated with any entity, but in preferred embodiments it may be associated with a website, social media site, or any remotely-hosted network presence that requires users to create unique, secure login or activation credentials. In one embodiment, third party system 550 may be a server that includes one or more processor(s), memory devices, and interface components configured to provide a cloud-based service. Third party system 550 may be a single server or a distributed computer system including multiple servers or computers that interoperate to perform one or more of the processes and functionalities associated with the disclosed embodiments. In some embodiments, third party system 550 may be the same server as remote data server 230, may share one or more architectural components, or may be managed by the same entity. In other embodiments, remote data server 230 and third party system 550 may be completely independent servers, and may be managed by different entities.

Although FIG. 5 describes a certain number of entities and processing/computing components within system environment 500, any number or combination of components may be implemented without departing from the scope of the disclosed embodiments. For example, in some embodiments more than one remote data server 530 or third party system 550 may be implemented. One skilled in the art will appreciate that the entities as described are not limited to their discrete descriptions above. Further, within system environment 500 the computing and processing devices and software executed by these components may be integrated into a local or distributed system. For example, the internal memory 114 of each of key duplication machines 110a-110n may be configured to store software instructions that when executed by the computing system may perform one or more functions relating to the combined components in a manner consistent with the disclosed embodiments.

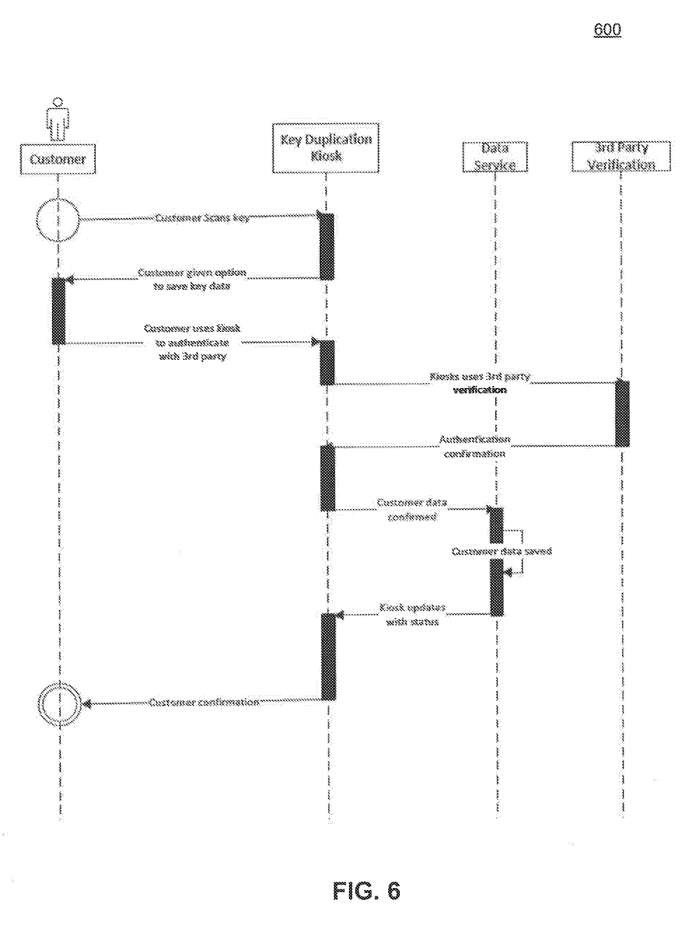

Exemplary operation of the disclosed systems and devices will now be described. FIG. 6 is a flowchart of an exemplary kiosk-controlled third party key data storage process 600, consistent with example embodiments disclosed herein. FIG. 6 will be described in connection with the components described above illustrated in FIG. 5 as being associated with system environment 500, but it is understood that other configurations are possible.

In one embodiment, a user 510 may approach any particular key duplication machine from among key duplication machines 110a-110n seeking to duplicate a master key and/or to save data associated with such a key for future duplications. This process may be similar to that described above in association with FIG. 3 and process 300. At any time during the duplication/storage process, user 510 may be asked by key duplication machine 110 (such as via a user interface or touchscreen associated with I/O devices 116) if they wish to store the key data determined by key identification module 120. If user 510 opts to save the data, key duplication machine 110 may prompt the user for information that may be utilized to identify user 510. In some embodiments, this information may include a username, password, or other such login credential associated with user 510 for a third party service associated with third party system 550.

Upon receiving the identification information via I/O devices 116, key duplication machine 110 may initiate a data storage process. Via network 540, key duplication machine 110 may send a request to third party system 550 seeking to verify user 510's identity. Third party system 550 may verify and confirm user 510's identity based on the submitted third party user credentials.

If the submitted third party user credentials match a set of credentials stored within third party server 550 associated with user 510, third party system 550 may transmit a communication to key duplication machine 110 indicating that user 510's identity has been verified. Additionally or alternatively, via network 540, third party system 550 may transmit a communication to user 510 to be received via user device 520. In some embodiments, the communication may be sent to a telephone number or device address associated with user device 520 previously input into key duplication machine 110 by user 510. Alternatively, if the submitted third party user credentials do not match a set of credentials stored within third party server 550 associated with user 510, third party system 550 may transmit a communication to key duplication machine 110 indicating that the key data cannot be stored due to an inability to verify the identity of user 510. In these embodiments, user 510 may be prompted to choose another method of verifying their identity; for example, the process described above in association with FIG. 3 and process 300. The communications are optimally transmitted within a period of several seconds up to several minutes from the time that user 510 indicated via key duplication machine 110 that they wished to store the determined key data.

Upon confirmation of user 510's identity, key duplication machine 110 may transmit a message to remote data server 530. The message may include information associated with user 510 and with key data associated with user 510 determined by key duplication machine 110. Remote data server 530 may proceed to store the key data within its associated memory devices and/or cloud storage platforms and devices. After successfully storing the data, remote data server 530 may transmit a communication to that effect to key duplication machine 110. Key duplication machine 110 may receive the message via communication interface 118, and may be configured to display a message to user 510 via I/O device 116 that the data storage was successful. Alternatively, system 200 may be configured such that remote data server 530 transmits the “data stored” communication directly to user 510 via user device 520.

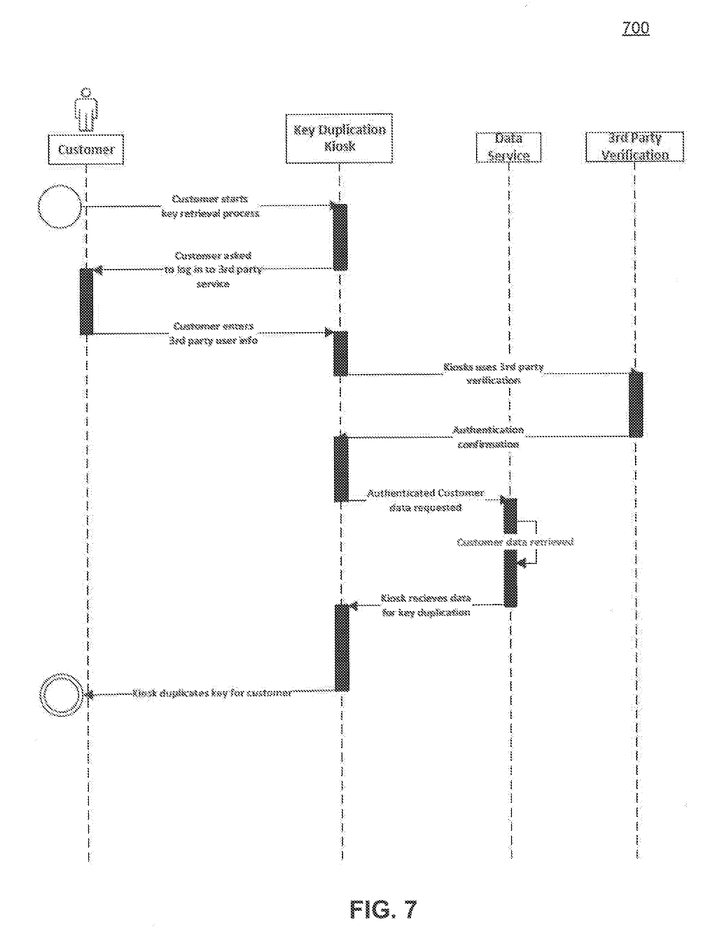

FIG. 7 is a flowchart of an exemplary kiosk-controlled third party key data retrieval process 700, consistent with example embodiments disclosed herein. FIG. 7 will be described in connection with the components described above illustrated in FIG. 5 as being associated with system environment 500, but it is understood that other configurations are possible.

In one embodiment, a user 510 may approach any particular key duplication machine from among key duplication machines 110a-110n seeking to duplicate a master key and/or to retrieve stored data associated with such a key from a past such duplication.

Via I/O devices 116, user 510 may interact with a key duplication machine 110. At any time during the interaction process, user 510 may be asked by key duplication machine 110 (such as via a user interface associated with I/O devices 116) if they wish to retrieve previously-stored key data. If user 510 opts to retrieve the data, key duplication machine 110 may prompt the user for information that may be utilized to identify user 510. In some embodiments, this information may include a username, password, or other such login credential associated with user 510 for a third party service associated with third party system 550.

Upon receiving the identification information via I/O devices 116, key duplication machine 110 may initiate a data retrieval process. Via network 540, key duplication machine 110 may send a request to third party system 550 seeking to verify user 510's identity. Third party system 550 may verify and confirm user 510's identity based on the submitted third party user credentials.

If the submitted third party user credentials match a set of credentials stored within third party server 550 associated with user 510, third party system 550 may transmit a communication to key duplication machine 110 indicating that user 510's identity has been verified. Additionally or alternatively, via network 540, third party system 550 may transmit a communication to user 510 to be received via user device 520. In some embodiments, the communication may be sent to a telephone number or device address associated with user device 520 previously input into key duplication machine 110 by user 510. Alternatively, if the submitted third party user credentials do not match a set of credentials stored within third party server 550 associated with user 510, third party system 550 may transmit a communication to key duplication machine 110 indicating that the key data cannot be retrieved due to an inability to verify the identity of user 510. In these embodiments, user 510 may be prompted to choose another method of verifying their identity; for example, the process described above in association with FIG. 4 and process 400. The communications are optimally transmitted within a period of several seconds up to several minutes from the time that user 510 indicated via key duplication machine 110 that they wished to retrieve previously-stored key data.

Upon confirmation of user 510's identity, key duplication machine 110 may transmit a request to remote data server 530 to retrieve key data associated with authenticated user 510. The request may include information associated with user 510 and with the key data associated with user 510 previously stored within remote data server 530. For example, in some embodiments the request may include a unique identifier associated with the stored key data previously assigned by one or more of a key duplication machine 110, remote data server 230/530, remote verification server 250, or third party system 550.

Remote data server 530 may proceed to retrieve the previously stored key data within its associated memory devices and/or cloud storage platforms and devices. After successfully retrieving the data, remote data server 530 may transmit a communication to that effect to key duplication machine 110. Key duplication machine 110 may receive the message via communication interface 118, and may be configured to display a message to user 510 via I/O device 116 that the data retrieval was successful. Alternatively, system 500 may be configured such that remote data server 530 transmits the “data retrieved” communication directly to user 510 via user device 520.

In these embodiments, remote data server 530 may proceed to transmit the stored key data associated with user 510 to key duplication machine 110. Key duplication machine 110 may be configured to receive the stored key data via communication interface 118, and via processor device 112 and key cutting module 122, may duplicate a key for user 510 based on the stored and retrieved key data. The key duplication process may proceed substantially as described above. Upon completion of the cutting of the key, key duplication machine 110 may provide the duplicated key to user 510.

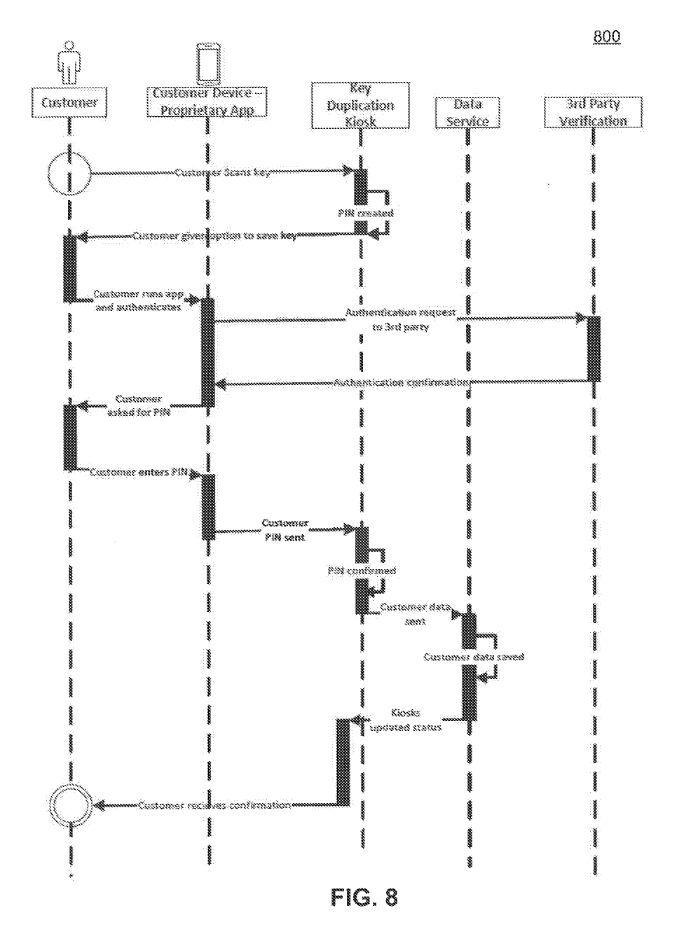

FIG. 8 is a flowchart of an exemplary device-controlled third party key data storage process 800, consistent with example embodiments disclosed herein. FIG. 8 will be described in connection with the components described above illustrated in FIG. 5 as being associated with system environment 500, but it is understood that other configurations are possible.

In one embodiment, a user 510 may approach any particular key duplication machine from among key duplication machines 110a-110n seeking to duplicate a master key and/or to save data associated with such a key for future duplications. This process may be similar to that described above in association with FIGS. 3 and 6 and processes 300 and 600. At any time during the duplication/storage process, user 510 may be asked by key duplication machine 110 (such as via a user interface or touchscreen associated with I/O devices 116) if they wish to store the key data determined by key identification module 120. If user 510 opts to save the data, key duplication machine 110, via processor device 112, may generate a first secure code, or personal identification number (PIN). The code may be generated based on a random number generator, or by other known methods. In some embodiments, the first PIN may be immediately displayed to user 510 on key duplication machine 110. In other embodiments, the first PIN may not be displayed to user 510 unless user 510 takes an affirmative action indicating that they wish to store their key data.

If user 510 opts to store the data, key duplication machine 110 may prompt the user to authenticate their identity via a proprietary mobile application accessible by user device 520. In these embodiments, the proprietary mobile application may be associated with and/or managed by the same entity that is associated with and/or manages key duplication machine 110. User device 520 may already be configured to access the proprietary mobile application, or the mobile application may be accessible on the web via network 540. Alternatively, user 510 may be guided in downloading the proprietary mobile application onto user device 520.

Upon opening the proprietary mobile application, user 510 may be prompted by the mobile application for information that may be utilized to identify user 510. In some embodiments, this information may include a username, password, or other such login credential associated with user 510 for a third party service associated with third party system 550. In some embodiments, user 510 may have the option of automatically linking the proprietary key duplication mobile application with data and information associated with the third party service, and thus may not be required to enter identifying information again. In these embodiments, user 510 may be required to have a mobile application associated with the third party service also available and/or open on user device 520.

Upon receiving or accessing the third party identification information associated with user 510, the proprietary mobile application associated with user device 520 may initiate a data storage process. Via network 540, the mobile application may send a request to third party system 550 seeking to verify user 510's identity. Third party system 550 may verify and confirm user 510's identity based on the submitted third party user credentials.

If the submitted third party user credentials match a set of credentials stored within third party server 550 associated with user 510, third party system 550 may transmit a communication to user device 520 and/or a computer system associated with the proprietary mobile application indicating that user 510's identity has been verified.

In some embodiments, the communication may include a personalized software object, or token, comprising an application programming interface. Third party system 550 may populate the software object with information associated with user 510. Any or all of key duplication machine 110, user device 520, remote data server 530, third party system 550, and/or a computer system associated with the proprietary mobile application may store the token in memory (such as memory devices 114) or on a separate associated external server. Additionally, security may be configured for the token to protect the privacy and fidelity of user 510's identification information and key data.

The communication may be transmitted directly through the mobile application. In other embodiments, the communication may be sent to a telephone number or device address associated with user device 520 previously input into key duplication machine 110 by user 510. Alternatively, if the submitted third party user credentials do not match a set of credentials stored within third party server 550 associated with user 510, third party system 550 may transmit a communication to user device 520 and/or a computer system associated with the proprietary mobile application indicating that the key data cannot be stored due to an inability to verify the identity of user 510. In these embodiments, user 510 may be prompted to choose another method of verifying their identity; for example, the process described above in association with FIG. 3 and process 300. The communications are optimally transmitted within a period of several seconds up to several minutes from the time that user 510 indicated via key duplication machine 110 that they wished to store key data.

Upon confirmation of user 510's identity, the proprietary mobile application may prompt user 510 via user device 520 to enter the first PIN previously displayed on key duplication machine. This process enhances security by ensuring that user 510, user device 520, and key duplication machine 110 are all in the same physical location.

If user 510 wishes to continue with the data storage process at that time, user 510 may proceed to enter the first PIN into user device 520 via the proprietary mobile application for verification. Alternatively, if user 510 declines to proceed, the first PIN may not be submitted. In these alternative embodiments, system 500 may be configured to set a time within which the first PIN may expire. The configured expiration time may be on the order of minutes, hours, days, weeks, etc. The first PIN may be configured to expire for security reasons and to keep the data storage process within the full control of user 510. Should the first PIN expire, user 510 may initiate the data storage process again upon a future visit to a key duplication machine 110a-110n.

If user 510 does choose to proceed, and enters a PIN into user device 520, user device 520 may transmit the entered PIN to key duplication machine 110 via network 540. Key duplication machine 110 may receive the transmitted PIN via communication interface 118, and may compare it to the first PIN previously displayed to user 510. If the PIN received from user device 520 does not match the displayed first PIN, key duplication machine 110 may display a notification via I/O devices 116 that the entered PIN number was incorrect. Alternatively, system 500 may be configured such that key duplication machine 110 transmits the “incorrect PIN” communication directly to user 510 via user device 520, such as through the proprietary mobile application.

If the PIN received does match the displayed first PIN, key duplication machine 110 may confirm user 510's identity (for example, via the token configured by third party system 550) and may transmit key data associated with user 510 to remote data server 530. Remote data server 530 may proceed to store the key data within its associated memory devices and/or cloud storage platforms and devices. After successfully storing the data, remote data server 530 may transmit a communication to that effect to key duplication machine 110. Key duplication machine 110 may receive the message via communication interface 118, and may be configured to display a message to user 510 via I/O device 116 that the PIN entered by user 510 was correct and that data storage was successful. Alternatively, system 500 may be configured such that remote data server 530 transmits the “correct PIN/data stored” communication directly to user 510 via user device 520.

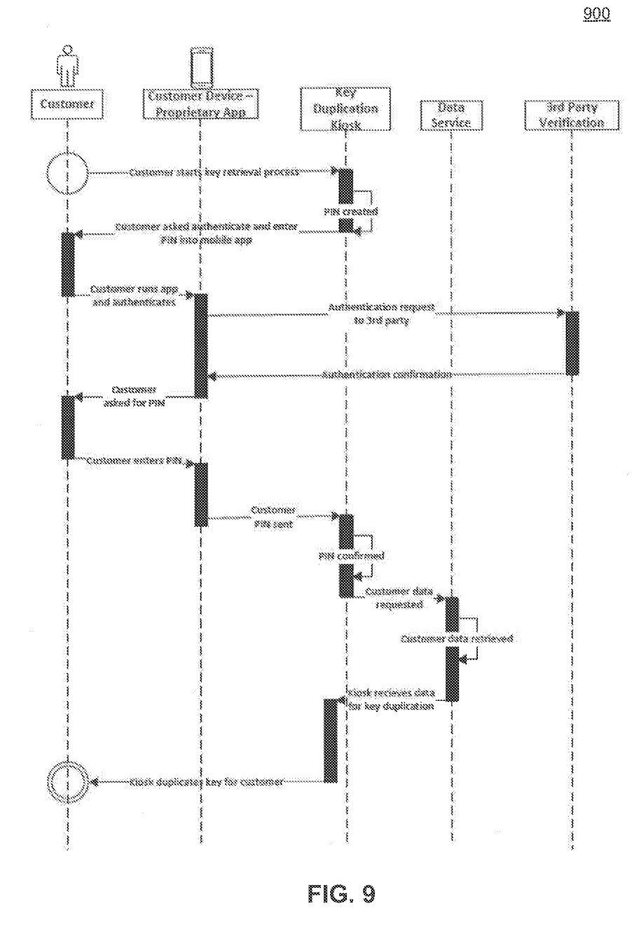

FIG. 9 is a flowchart of an exemplary device-controlled third party key data retrieval process 900, consistent with example embodiments disclosed herein. FIG. 9 will be described in connection with the components described above illustrated in FIG. 5 as being associated with system environment 500, but it is understood that other configurations are possible.

In one embodiment, a user 510 may approach any particular key duplication machine from among key duplication machines 110a-110n seeking to duplicate a master key and/or to save data associated with such a key for future duplications. This process may be similar to that described above in association with FIGS. 4 and 7 and processes 400 and 700. User 510 may indicate to key duplication machine 110 that they wish to retrieve previously-stored key data via one or more inputs to key duplication machine 110 via I/O devices 116. Upon receiving such an input, key duplication machine 110, via processor device 112, may generate a second secure code, or personal identification number (PIN). The code may be generated based on a random number generator, or by other known methods. In some embodiments, the second PIN may be different from the first PIN (described in association with FIG. 8 and process 800 above) generated when user 510 stored the key data previously. In other embodiments, the first and second PINs may be the same.

If user 510 opts to retrieve previously-stored key data, key duplication machine 110 may prompt the user to authenticate their identity via a proprietary mobile application accessible by user device 520. In these embodiments, the proprietary mobile application may be associated with and/or managed by the same entity that is associated with and/or manages key duplication machine 110. User device 520 may already be configured to access the proprietary mobile application, or the mobile application may be accessible on the web via network 540. Alternatively, user 510 may be guided in downloading the proprietary mobile application onto user device 520.

Upon opening the proprietary mobile application, user 510 may be prompted by the mobile application for information that may be utilized to identify user 510. In some embodiments, this information may include a username, password, or other such login credential associated with user 510 for a third party service associated with third party system 550. In some embodiments, user 510 may have the option of automatically linking the proprietary key duplication mobile application with data and information associated with the third party service, and thus may not be required to enter identifying information again. In these embodiments, user 510 may be required to have a mobile application associated with the third party service also available and/or open on user device 520.

Upon receiving or accessing the third party identification information associated with user 510, the proprietary mobile application associated with user device 520 may initiate a data retrieval process. Via network 540, the mobile application may send a request to third party system 550 seeking to verify user 510's identity. Third party system 550 may verify and confirm user 510's identity based on the submitted third party user credentials.

If the submitted third party user credentials match a set of credentials stored within third party server 550 associated with user 510, third party system 550 may transmit a communication to user device 520 and/or a computer system associated with the proprietary mobile application indicating that user 510's identity has been verified.

In some embodiments, the communication may include a personalized software object, or token, comprising an application programming interface. Third party system 550 may populate the software object with information associated with user 510. Any or all of key duplication machine 110, user device 520, remote data server 530, third party system 550, and/or a computer system associated with the proprietary mobile application may store the token in memory (such as memory devices 114) or on a separate associated external server. Additionally, security may be configured for the token to protect the privacy and fidelity of user 510's identification information and key data.

The communication may be transmitted directly through the mobile application. In other embodiments, the communication may be sent to a telephone number or device address associated with user device 520 previously input into key duplication machine 110 by user 510. Alternatively, if the submitted third party user credentials do not match a set of credentials stored within third party server 550 associated with user 510, third party system 550 may transmit a communication to user device 520 and/or a computer system associated with the proprietary mobile application indicating that the key data cannot be retrieved due to an inability to verify the identity of user 510. In these embodiments, user 510 may be prompted to choose another method of verifying their identity; for example, the process described above in association with FIG. 4 and process 400. The communications are optimally transmitted within a period of several seconds up to several minutes from the time that user 510 indicated via key duplication machine 110 that they wished to retrieve previously-stored key data.

Upon confirmation of user 510's identity, the proprietary mobile application may prompt user 510 via user device 520 to enter the second PIN previously displayed on key duplication machine. This process enhances security by ensuring that user 510, user device 520, and key duplication machine 110 are all in the same physical location.

If user 510 wishes to continue with the data retrieval process at that time, user 510 may proceed to enter the second PIN into user device 520 via the proprietary mobile application for verification. Alternatively, if user 510 declines to proceed, the second PIN may not be submitted. In these alternative embodiments, system 500 may be configured to set a time within which the second PIN may expire. The configured expiration time may be on the order of minutes, hours, days, weeks, etc. The second PIN may be configured to expire for security reasons and to keep the data retrieval process within the full control of user 510. Should the second PIN expire, user 510 may initiate the data retrieval process again upon a future visit to a key duplication machine 110a-110n.

If user 510 does choose to proceed, and enters a PIN into user device 520, user device 520 may transmit the entered PIN to key duplication machine 110 via network 540. Key duplication machine 110 may receive the transmitted PIN via communication interface 118, and may compare it to the second PIN previously displayed to user 510. If the PIN received from user device 520 does not match the displayed second PIN, key duplication machine 110 may display a notification via I/O devices 116 that the entered PIN number was incorrect. Alternatively, system 500 may be configured such that key duplication machine 110 transmits the “incorrect PIN” communication directly to user 510 via user device 520, such as through the proprietary mobile application.

If the PIN received does match the displayed second PIN, key duplication machine 110 may confirm user 510's identity (for example, via the token configured by third party system 550) and may request retrieval of previously stored key data from remote data server 530 via network 540. Remote data server 530 may proceed to retrieve the previously-stored key data from within its associated memory devices and/or cloud storage platforms and devices. After successfully retrieving the data, remote data server 530 may transmit a communication to that effect to key duplication machine 110 comprising the retrieved data. Key duplication machine 110 may receive the communication via communication interface 118, and may be configured to display a message to user 510 via I/O device 116 that the PIN entered by user 510 was correct and that data retrieval was successful. Alternatively, system 500 may be configured such that remote data server 530 transmits the “correct PIN/data retrieved” communication directly to user 510 via user device 520.

Key duplication machine 110 may be configured to receive the stored key data via communication interface 118, and via processor device 112 and key cutting module 122, may duplicate a key for user 510 based on the stored and retrieved key data. The key duplication process may proceed substantially as described above. Upon completion of the cutting of the key, key duplication machine 110 may provide the duplicated key to user 510.

The data retrieval processes described above, including processes 400, 700, and 900, may each alternatively be configured in a manner such that user 210 or user 510 need not be physically present at a key duplication machine 110 in order to retrieve key data and have a key cut in accordance with the retrieved data. For example, user 210 or user 510 may be able to request a key be cut in accordance with previously-stored key data via a proprietary mobile application or a web interface via user device 220 or 520. The entity associated with the mobile application and/or key duplication machines 110a-110n may cut such a key at a remote location, then ship it to user 210 or user 510 at a mailing address indicated by the user.

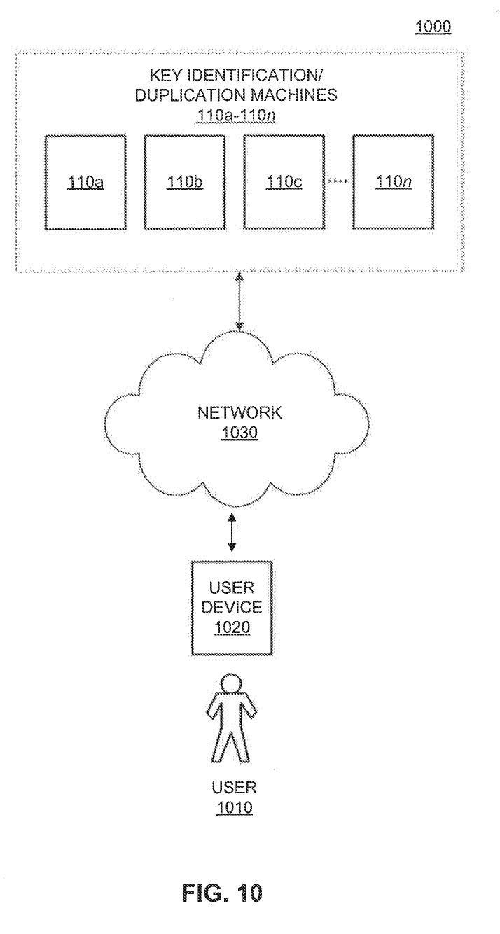

FIG. 10 illustrates an exemplary system 1000 consistent with disclosed embodiments. In one aspect, system environment 1000 may include multiple integrated key duplication machines 110a-110n. Each of key duplication machines 110a-110n may be substantially as described above.

User 1010 may represent a customer or potential customer of a retail establishment. In alternative embodiments, user 1010 may represent an employee of the retail establishment. User 1010 may be untrained or have limited training in aspects of key duplication.

User device(s) 1020 may include one or more processors configured to execute software instructions stored in memory, such as memory included in user device 1020. User device 1020 may include software executable by a processor to perform Internet-related communication and content presentation processes. For instance, user device 1020 may execute software that generates and displays interfaces and/or content on a presentation device included in, or connected to, user device 1020, or on one of key duplication machines 110a-110n via a particular machine's I/O device(s) 116. User device 1020 may be a mobile device that executes mobile device applications and/or mobile device communication software that allows user device 1020 to communicate with other system components over network 1030. The disclosed embodiments are not limited to any particular configuration of user device 1020.

The various components of system environment 1000 may be commonly linked to a network 1030 for purposes of communication and workflow distribution among the components. Network 1030 may be any type of network that facilitates communications and data transfer, such as, for example, a Local Area Network (LAN), or a Wide Area Network (WAN), such as the Internet. Network 1030 may be a single network or a combination of networks. Further, network 1030 may comprise a single type of network or a combination of different types of networks, such as the Internet and public exchange networks for wireline and/or wireless communications. Network 1030 may also comprise private networks for wireline and/or wireless communications. For example, a merchant or retailer (not shown in system environment 1000) may provide access to the Internet via private networks not accessible by members of the general public. Network 1030 may utilize cloud computing technologies that are known in the marketplace. One skilled in the art would recognize that network 1030 is not limited to the above examples and that system 1000 may implement and incorporate any type of network that allows the entities (and others not shown) included in FIG. 10 to exchange data and information.

Although FIG. 10 describes a certain number of entities and processing/computing components within system environment 1000, any number or combination of components may be implemented without departing from the scope of the disclosed embodiments. One skilled in the art will appreciate that the entities as described are not limited to their discrete descriptions above. Further, within system environment 1000 the computing and processing devices and software executed by these components may be integrated into a local or distributed system. For example, the internal memory 114 of each of key duplication machines 110a-110n may be configured to store software instructions that when executed by the computing system may perform one or more functions relating to the combined components in a manner consistent with the disclosed embodiments.

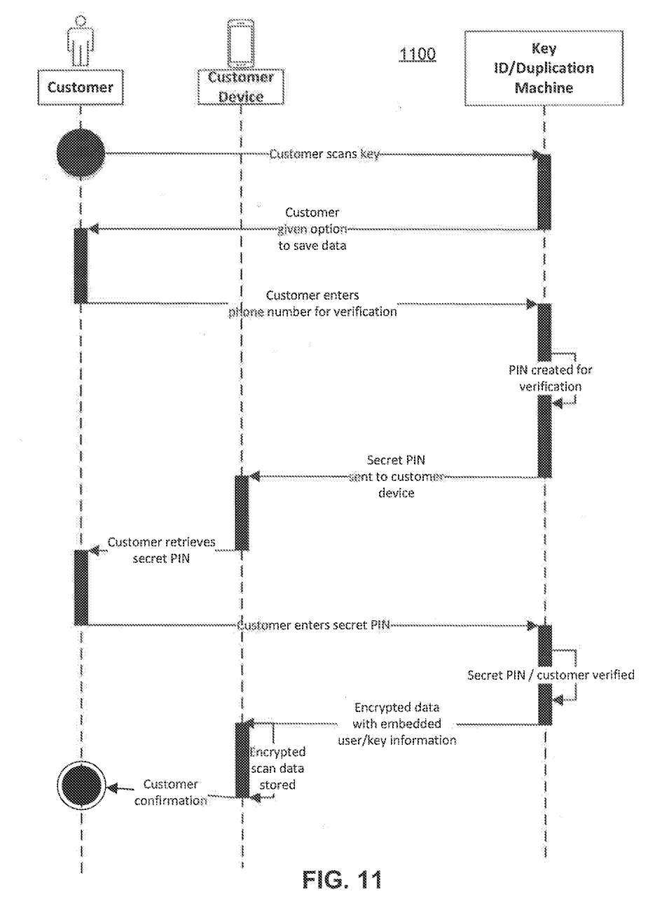

Exemplary operation of the disclosed systems and devices will now be described. FIG. 11 is a flowchart of an exemplary key data storage process 1100, consistent with example embodiments disclosed herein. FIG. 11 will be described in connection with the components described above illustrated in FIG. 10 as being associated with system environment 1000, but it is understood that other configurations are possible.

In one embodiment, a user 1010 may approach any particular key duplication machine from among key duplication machines 110a-110n seeking to duplicate a master key and/or to save data associated with such a key for future duplications. User 1010 may insert the master key into a dedicated receptacle within key duplication machine 110 for identification.

Key duplication machine 110 may determine a key blank corresponding to the received first master key using the machine-based devices housed within key identification module 120 described above. In some embodiments, key identification module 120 may determine the proper key blank by capturing an image, using a machine vision-based system. In these embodiments, module 120 may capture the image as a digital image using a camera. In other embodiments, an image may be captured using a laser scanner. These examples are not intended to be limiting, and a skilled artisan may contemplate various means of determining the proper key blank corresponding to the inserted master key.

Key duplication machine 110 may be further configured to determine the bitting pattern of the inserted master key of user 1010. The bitting pattern may comprise, for example, the cuts in the key blade, or may include notches, depressions, or other such features on one or both edges of the key blade. Alternatively, the bitting pattern may comprise cuts on the broad side of the blade itself, such as those created by a milling machine. Key identification module 120 may determine the bitting pattern of user 1010's master key using similar machine-based systems as described previously. In some embodiments, key duplication machine 110 may store the determined key blank information and bitting pattern in a database or memory device included in its computer system, such as memory 114. Alternatively, the bitting pattern information may be stored as a captured image, such that an exact notch pattern may be subsequently discerned by a key cutting machine or module.

Key duplication machine 110 may optionally proceed to cut the determined bitting pattern of the first master key into a key blank via one or more key cutters as discussed previously. At any time during the above-described process, user 1010 may be asked by key duplication machine 110 (such as via a user interface or touchscreen associated with I/O devices 116) if they wish to store key data determined by key identification module 120 of key duplication machine 110. If user 1010 opts to save the data, key duplication machine 110 may prompt the user for information that may be utilized to identify user 1010. This information may include, but not be limited to, a telephone number associated with user 1010 or a user device 1020, an IP (Internet Protocol) address associated with user 1010 or a user device 1020, a MAC (media access control) address associated with user 1010 or a user device 1020, or any other identification specific to user 1010, including but not limited to a unique identifier assigned to user 1010 by an entity associated with key duplication machine 110.

Upon receiving the identification information via I/O devices 116 or user device 1020, key duplication machine 110 may initiate a data storage process via network 1030. Via one or more integrated processor devices, such as processor device 112, key duplication machine 110 may generate a first secure code, or personal identification number (PIN). The code may be generated based on a random number generator, or by other known methods.

Via network 1030, key duplication machine 110 may transmit a communication to user 1010 to be received via user device 1020. In some embodiments, the communication may be sent to the telephone number or device address associated with user device 1020 previously input into key duplication machine 110 by user 1010. The communication is optimally transmitted within a period of several seconds up to several minutes from the time that user 1010 indicated via key duplication machine 110 that they wished to store the determined key data.

In these embodiments, user 1010 may receive the transmitted communication from key duplication machine 110 via user device 1020. The communication, comprising the first PIN, may be sent via SMS (short message service), text messaging, email, social media, or other such methods known to one of skill in the art. For security purposes, the communication transmitted by key duplication machine 110 may include instructions intended for user 1010. These instructions may include, for example, directions for how to securely confirm receipt of the first PIN.

In some embodiments, the instructions may prompt user 1010 to enter the received first PIN into a user interface displayed on an I/O device 116 of key duplication machine 110. If user 1010 wishes to continue with the data storage process at that time, user 1010 may retrieve the first PIN from user device 1020, and proceed to submit the first PIN to key duplication machine 110 for verification. Alternatively, if user 1010 declines to proceed, the first PIN may not be submitted. In these alternative embodiments, system 1000 may be configured to set a time within which the first PIN may expire. The configured expiration time may be on the order of minutes, hours, days, weeks, etc. The first PIN may be configured to expire for security reasons and to keep the data storage process within the full control of user 1010. Should the first PIN expire, user 1010 may initiate the data storage process again upon a future visit to a key duplication machine 110a-110n.

If user 1010 does choose to proceed, and enters a PIN into key duplication machine 110, key duplication machine 110, via communication interface 118, may receive the transmitted PIN, and may compare it to the first PIN previously transmitted to user device 1020. If the PIN received from the user by key duplication machine 110 does not match the transmitted first PIN, key duplication machine 110 may be configured to not save the key data, and may transmit a communication to that effect to key duplication machine 110. Key duplication machine 110 may receive the message via communication interface 118, and may be configured to display a message to user 1010 via I/O device 116 that the PIN entered by user 1010 was incorrect. Alternatively, system 1000 may be configured such that the “incorrect PIN” communication is displayed directly to user 1010 via user device 1020.

If the PIN received by key duplication machine 110 does match the first PIN previously transmitted to user 1010, key duplication machine 110 may confirm user 1010's identity and the key data associated with user 1010. In some embodiments, key duplication machine 110 may be configured to display a message to user 1010 via I/O device 116 that the PIN entered by user 1010 was correct. Alternatively, system 1000 may be configured such that key duplication machine 110 transmits the “correct PIN” communication directly to user 1010 via user device 1020.

With the identity of user 1010 verified, key duplication machine 110 may proceed to encrypt the determined key blank information and bitting pattern information associated with any or all master keys presented for duplication at key duplication machine 110 by user 1010. Key duplication machine 110 may further add additional information to the encrypted data. The additional information may include, but not be limited to, the first PIN generated by key duplication machine 110, the telephone number or device address associated with user device 1020, information associated with a mobile application and with user 1010, information associated with a third-party service and with user 1010, such as an account associated with a cloud-based service or social media service, the date that the key data was originally stored, the location where the key data was originally stored, a user “label” for the key such as a name or description, etc.

Key duplication machine 110 may proceed to transmit the encrypted data (with embedded additional information) to user device 1020, where it may be securely stored. Depending on the embodiment, user device 1020 may be configured to store the encrypted key data on a local memory device. In other embodiments, user device 1020 may be configured to store the encrypted key data via cloud-based storage associated with the manufacturer of user device 1020 and/or a service provider of user device 1020, such as a wireless carrier. User 1010 may confirm receipt and storage of the data through user device 1020, such as through a mobile application or by a return SMS/text message or email.

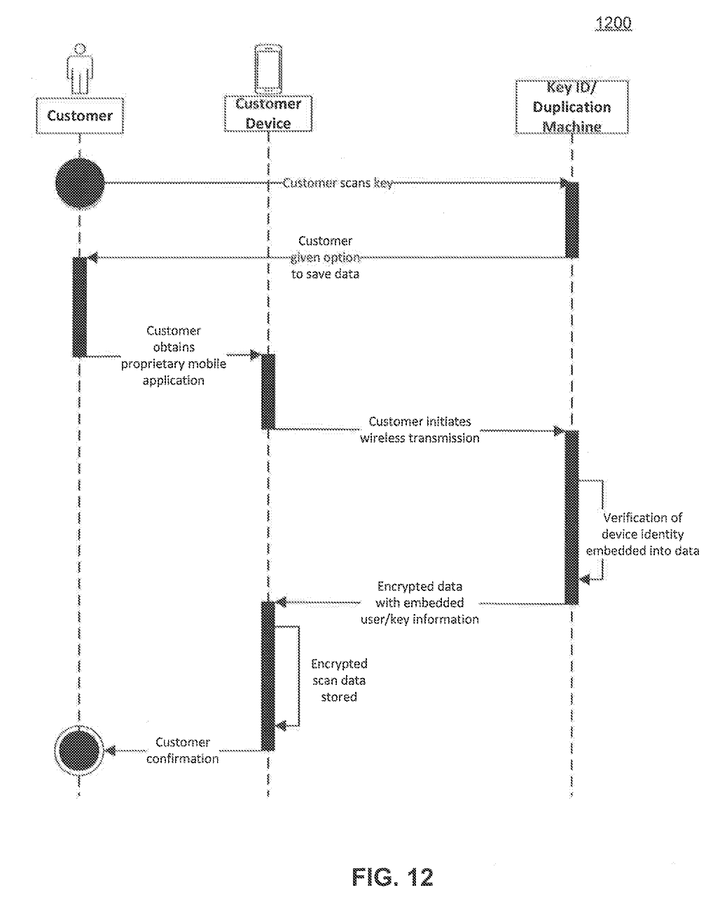

In some embodiments, the data storage process described in association with FIG. 11 may be modified to utilize wireless communication technology rather than text or email messaging. The wireless communication technology may include one or more of cellular, WiFi, Bluetooth transceivers, near-field communication (NFC) components, or any other wireless transceivers or communication equipment. In alternative embodiments, wired internet connections or DSL may be utilized. FIG. 12 is a flowchart of an exemplary key data storage process 1200, consistent with example embodiments disclosed herein. FIG. 12 will be described in connection with the components described above illustrated in FIG. 10 as being associated with system environment 1000, but it is understood that other configurations are possible.

In one embodiment, a user 1010 may approach any particular key duplication machine from among key duplication machines 110a-110n seeking to duplicate a master key and/or to save data associated with such a key for future duplications, substantially as described above in association with FIG. 11 and process 1100.

At any time during the above-described process, user 1010 may be asked by key duplication machine 110 (such as via a user interface or touchscreen associated with I/O devices 116) if they wish to store key data determined by key identification module 120 of key duplication machine 110. If user 1010 opts to save the data, key duplication machine 110 may prompt the user for information that may be utilized to identify user 1010.

Upon receipt of the prompt for information, user 1010 may acquire, or may have previously acquired, a proprietary mobile application via an operating system associated with user device 1020. The mobile application may be associated with the owner and/or manufacturer of key duplication machine 110, or alternatively, a retail location where key duplication machine 110 is installed and operated. The mobile application may be configured to receive information from user 1010 and/or user device 1020 sufficient to uniquely identify user 1010 and/or user device 1020.

In these embodiments, user device 1020 may be configured with hardware components, operating systems, and/or software applications that enable user device 1020 to communicate with similarly configured devices using wireless communication technology as discussed above. Key duplication machine 110 may also be configured to support such wireless communication technology, and may have a portion of its housing or touchscreen visibly designated as being a receiver for wireless transmissions or communications.

In process 1200, after deciding to store key data, user 1010 may initiate a wireless communication via a suitably-equipped user device 1020 on or sufficiently near the region of key duplication machine 110 designated for receiving wireless transmissions or communications. In some embodiments, user device 1020 and key duplication machine 110 may make physical contact in the course of transferring the user information. In other embodiments, the information may be transmitted when user device 1020 and key duplication machine 110 are brought within a specified distance of one another, such as 1 to 4 centimeters.

If the wireless transmission by user device 1020 is successful, key duplication machine 110 may confirm user 1010's identity and the key data associated with user 1010. In some embodiments, key duplication machine 110 may be configured to display a message to user 1010 via I/O device 116 that the wireless transmission was successful. Alternatively, system 1000 may be configured such that key duplication machine 110 transmits a communication directly to user 1010 via user device 1020.

With the identity of user 1010 verified, key duplication machine 110 may proceed to encrypt the determined key blank information and bitting pattern information associated with any or all master keys presented for duplication at key duplication machine 110 by user 1010. Key duplication machine 110 may further add additional information to the encrypted data. The additional information may include, but not be limited to, the first PIN generated by key duplication machine 110, the telephone number or device address associated with user device 1020, information associated with a mobile application and with user 1010, information associated with a third-party service and with user 1010, such as an account associated with a cloud-based service or social media service, the date that the key data was originally stored, the location where the key data was originally stored, a user “label” for the key such as a name or description, etc.

Key duplication machine 110 may proceed to transmit the encrypted data (with embedded additional information) to user device 1020, where it may be securely stored. The transmission may be effected by wireless communication or by any of the other means of transmission via network 1030 described above. Depending on the embodiment, user device 1020 may be configured to store the encrypted key data on a local memory device. In other embodiments, user device 1020 may be configured to store the encrypted key data via cloud-based storage associated with the manufacturer of user device 1020 and/or a service provider of user device 1020, such as a wireless carrier. User 1010 may confirm receipt and storage of the data through user device 1020, such as through a mobile application or by a return SMS/text message or email.

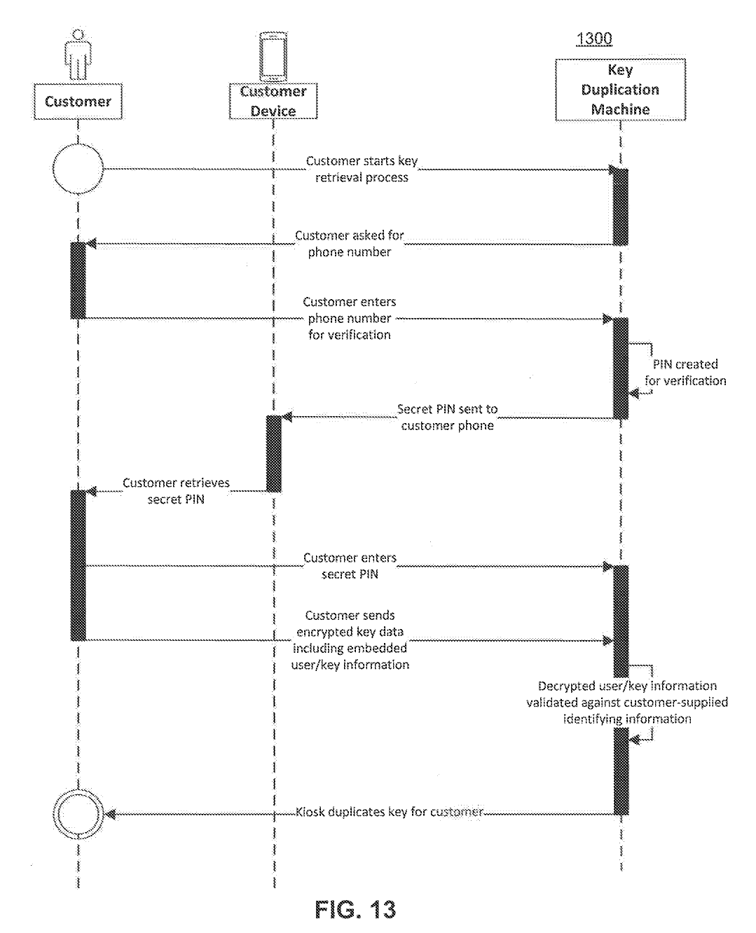

FIG. 13 is a flowchart of an exemplary key data retrieval process 1300, consistent with example embodiments disclosed herein. FIG. 13 will be described in connection with the components described above illustrated in FIG. 10 as being associated with system environment 1000, but it is understood that other configurations are possible. Process 1300 is a data retrieval process that may be used to retrieve data stored using a process similar to that described above in as process 1100 in association with FIG. 11. However, in some embodiments, process 1300 may be used with other data storage processes, for example, process 1200 described above in association with FIG. 12.

In one embodiment, user 1010 may approach any particular key duplication machine from among key duplication machines 110a-110n seeking to duplicate a master key and/or to retrieve stored data associated with such a key from a past such duplication.

Via I/O devices 116, user 1010 may interact with a key duplication machine 110. At any time during the interaction process, user 1010 may be asked by key duplication machine 110 (such as via a user interface associated with I/O devices 116) if they wish to retrieve previously-stored key data. If user 1010 opts to retrieve the data, key duplication machine 110 may prompt the user for information that may be utilized to identify user 1010. As discussed above, this information may include, but not be limited to, a telephone number associated with user 1010 and/or a user device 1020, an IP (Internet Protocol) address associated with user 1010 or a user device 1020, a MAC (media access control) address associated with user 1010 or a user device 1020, or any other identification specific to user 1010, including but not limited to a unique identifier assigned to user 1010 by an entity associated with key duplication machine 110.

Upon receiving the identification information via I/O devices 116, key duplication machine 110 may initiate the data retrieval process by verifying user 1010's identity. Via one or more integrated processor devices, such as processor device 112, key duplication machine 110 may determine whether the identification information submitted by user 1010 to key duplication machine 110 matches that previously submitted by any other user. If the data does not match any previous identification information, via I/O devices 116, key duplication machine 110 may inform user 1010 that their information was not found, and may invite user 1010 to attempt to submit the identification information a second time.

If the submitted identification information does match a previously-recognized user 1010, key duplication machine 110 (via processor device 112) may generate a second secure code, or personal identification number (PIN). The code may be generated based on a random number generator, or by other known methods. In some embodiments, the second PIN is different than a first PIN generated during a data storage process similar to process 1100 described above. In alternative embodiments, the second PIN may be the same as the first PIN.

Via network 1030, key duplication machine 110 may transmit a communication to user 1010 to be received via user device 1020. In some embodiments, the communication may be sent to the telephone number or device address associated with user device 1020 previously input into key duplication machine 110 by user 1010. The communication is optimally transmitted within a period of several seconds up to several minutes from the time that user 1010 indicated via key duplication machine 110 that they wished to retrieve the previously-stored key data.

In these embodiments, user 1010 may receive the transmitted communication from key duplication machine 110 via user device 1020. The communication, comprising the second PIN, may be sent via SMS, text messaging, email, social media, or other such methods known to one of skill in the art. For security purposes, the communication transmitted by key duplication machine 110 may include instructions intended for user 1010. These instructions may include, for example, directions for how to securely confirm receipt of the second PIN.

In some embodiments, the instructions may prompt user 1010 to enter the received second PIN into a user interface displayed on an I/O device 116 of key duplication machine 110. If user 1010 wishes to continue with the data retrieval process at that time, user 1010 may proceed to submit the second PIN to key duplication machine 110 for verification. Alternatively, if user 1010 declines to proceed, the second PIN may not be submitted. In these alternative embodiments, system 1000 (via key duplication machine 110) may be configured to set a time within which the second PIN may expire. The configured expiration time may be on the order of minutes, hours, days, weeks, etc. The second PIN may be configured to expire for security reasons and to keep the data storage process within the full control of user 1010. Should the second PIN expire, user 1010 may initiate the data storage process again upon a future visit to a key duplication machine 110a-110n.

If user 1010 does choose to proceed, and enters a PIN into key duplication machine 110, key duplication machine 110 may compare it to the second PIN previously transmitted to user device 1020. If the PIN received by key duplication machine 110 does not match the transmitted second PIN, key duplication machine 110 may be configured to not proceed any further with process 1300, and may transmit a communication to that effect to user 1010 or user device 1020.

In some embodiments, user 1010 may be prompted to also provide to key duplication machine 110 a previously-received encrypted key data file that was the output of a key data storage process such as process 1100. The data file may be transmitted to key duplication machine 110 by user 1010 via user device 1020 before, during, or after the time at which user 1010 submits the second PIN to key duplication machine 110 via I/O devices 116.

If the PIN received does match the transmitted second PIN, key duplication machine 110, via processor device 112, may confirm user 1010's identity and/or that of user device 1020. Key duplication machine 110 may transmit a communication to user 1010 via user device 1020 indicating that user 1010 has been verified and confirmed. Key duplication machine 110, via the processor device(s) 112, may execute software instructions to decrypt the received stored key data associated with user 1010 and user device 1020, and may convert the data into a form readable by other modules of key duplication machine 110. In these embodiments, key duplication machine 110 may proceed to isolate the embedded additional information associated with the key data during the storage and encryption process that may be used to verify the identity of user 1010, such as the first PIN generated by key duplication machine 110, the telephone number or device address associated with user device 1020, information associated with a mobile application and with user 1010, information associated with a third-party service and with user 1010, such as an account associated with a cloud-based service or social media service, the date that the key data was originally stored, the location where the key data was originally stored, a user “label” for the key such as a name or description, etc.

In these embodiments, with the identity of user 1010 verified, key duplication machine 110 may be configured to analyze the decrypted, stored key data via communication interface 118, and via processor device 112 and key cutting module 122, may duplicate a key for user 1010 based on the stored and retrieved key data. The key duplication process may proceed substantially as described above. Upon completion of the cutting of the key, key duplication machine 110 may provide the duplicated key to user 1010.

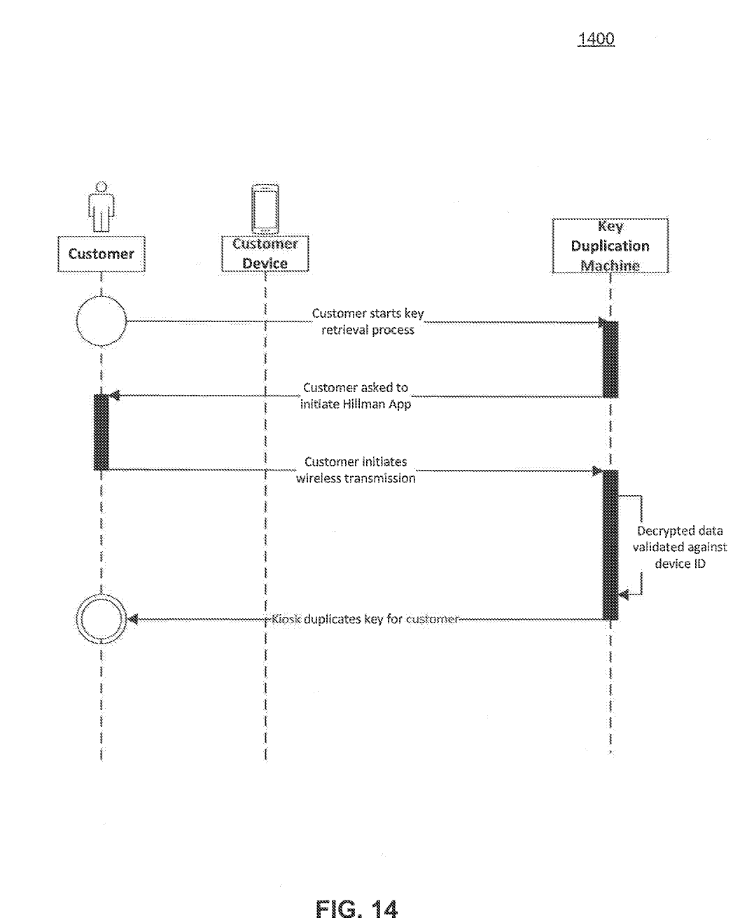

In some embodiments, the data storage process described in association with FIG. 13 may be modified to utilize wireless communication technology rather than text or email messaging. The wireless communication technology may include one or more of cellular, WiFi, Bluetooth transceivers, near-field communication (NFC) components, or any other wireless transceivers or communication equipment. In alternative embodiments, wired internet connections or DSL may be utilized. FIG. 14 is a flowchart of an exemplary key data storage process 1400, consistent with example embodiments disclosed herein. FIG. 14 will be described in connection with the components described above illustrated in FIG. 10 as being associated with system environment 1000, but it is understood that other configurations are possible.

In one embodiment, user 1010 may approach any particular key duplication machine from among key duplication machines 110a-110n seeking to duplicate a master key and/or to retrieve stored data associated with such a key from a past such duplication.

At any time during the above-described process, user 1010 may be asked by key duplication machine 110 (such as via a user interface or touchscreen associated with I/O devices 116) if they wish to retrieve previously-stored key data. If user 1010 opts to retrieve the data, key duplication machine 110 may prompt the user for information that may be utilized to identify user 1010.

Upon receipt of the prompt for information, user 1010 may acquire, or may have previously acquired, a proprietary mobile application via an operating system associated with user device 1020. The mobile application may be associated with the owner and/or manufacturer of key duplication machine 110, or alternatively, a retail location where key duplication machine 110 is installed and operated. The mobile application may be configured to receive information from user 1010 and/or user device 1020 sufficient to uniquely identify user 1010 and/or user device 1020.

In these embodiments, user device 1020 may be configured with hardware components, operating systems, and/or software applications that enable user device 1020 to communicate with similarly configured devices using wireless communication technology, as described above. Key duplication machine 110 may also be configured to support such wireless communication technology, and may have a portion of its housing or touchscreen visibly designated as being a receiver for wireless transmissions or communications.

In process 1400, after deciding to retrieve key data, user 1010 may initiate a wireless communication using a suitably-equipped user device 1020 on or sufficiently near the region of key duplication machine 110 designated for receiving wireless transmissions or communications. In some embodiments, user device 1020 and key duplication machine 110 may make physical contact in the course of transferring the user information. In other embodiments, the information may be transmitted when user device 1020 and key duplication machine 110 are brought within a specified distance of one another, such as 1 to 4 centimeters.

The wireless transmission may contain the encrypted stored key data file stored by and/or within user device 1020 during a key data storage process similar to processes 1100 or 1300. If the wireless transmission by user device 1020 is successful, key duplication machine 110 may confirm user 1010's identity and may decrypt the key data associated with user 1010. In some embodiments, key duplication machine 110 may be configured to display a message to user 1010 via I/O device 116 that the wireless transmission was successful. Alternatively, system 1000 may be configured such that key duplication machine 110 transmits a communication directly to user 1010 via user device 1020.

Key duplication machine 110, via the processor device(s) 112, may execute software instructions to convert the decrypted transmitted key data into a form readable by other modules of key duplication machine 110.

In these embodiments, key duplication machine 110 may be configured to analyze the decrypted, stored key data via communication interface 118, and via processor device 112 and key cutting module 122, may duplicate a key for user 1010 based on the stored and retrieved key data. The key duplication process may proceed substantially as described above. Upon completion of the cutting of the key, key duplication machine 110 may provide the duplicated key to user 1010.

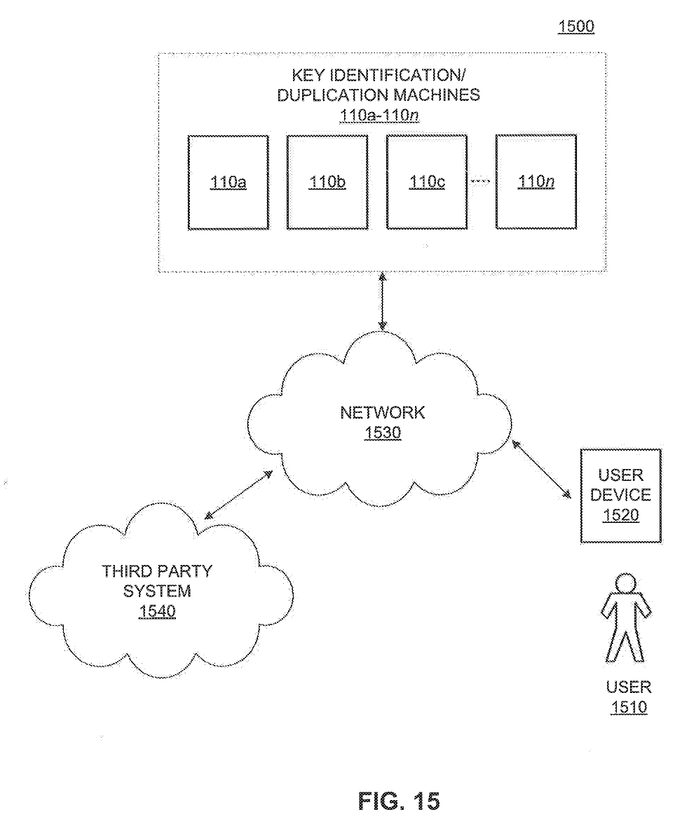

FIG. 15 illustrates an exemplary system 1500 consistent with disclosed embodiments. In one aspect, system environment 1500 may include multiple integrated key duplication machines 110a-110n. Each of key duplication machines 110a-110n may be substantially as described above.

User 1510 may represent a customer or potential customer of a retail establishment. In alternative embodiments, user 1510 may represent an employee of the retail establishment. User 1510 may be untrained or have limited training in aspects of key duplication. In some embodiments, user 1510 may be associated with one or more profiles, accounts, or other such presence on a network-accessible entity, such as a website, a social network, or any third party-controlled data hosted on a remote server.

User device(s) 1520 may include one or more processors configured to execute software instructions stored in memory, such as memory included in user device 1520. User device 1520 may include software executable by a processor to perform Internet-related communication and content presentation processes. For instance, user device 1520 may execute software that generates and displays interfaces and/or content on a presentation device included in, or connected to, user device 1520, or on one of key duplication machines 110a-110n via a particular machine's I/O device(s) 116. User device 1520 may be a mobile device that executes mobile device applications and/or mobile device communication software that allows user device 1520 to communicate with other system components over network 1530, for example, third party system 1540. The disclosed embodiments are not limited to any particular configuration of user device 1520.

The various components of system environment 1500 may be commonly linked to a network 1530 for purposes of communication and workflow distribution among the components. Network 1530 may be any type of network that facilitates communications and data transfer, such as, for example, a Local Area Network (LAN), or a Wide Area Network (WAN), such as the Internet. Network 1530 may be a single network or a combination of networks. Further, network 1530 may comprise a single type of network or a combination of different types of networks, such as the Internet and public exchange networks for wireline and/or wireless communications. Network 1530 may also comprise private networks for wireline and/or wireless communications. For example, a merchant or retailer (not shown in system environment 1500) may provide access to the Internet via private networks not accessible by members of the general public. Network 1530 may utilize cloud computing technologies that are known in the marketplace. One skilled in the art would recognize that network 1530 is not limited to the above examples and that system 1500 may implement and incorporate any type of network that allows the entities (and others not shown) included in FIG. 15 to exchange data and information.

Third party system 1540 may be a computer-based system including computer system components, such as one or more servers, desktop computers, workstations, tablets, hand held computing devices, memory devices, and/or internal network(s) connecting the components. Third party system 1540 may be associated with any entity, but in preferred embodiments it may be associated with a website, social media site, or any remotely-hosted network presence that requires users to create unique, secure login or activation credentials. In one embodiment, third party system 1540 may be a server that includes one or more processor(s), memory devices, and interface components configured to provide a cloud-based service. Third party system 1540 may be a single server or a distributed computer system including multiple servers or computers that interoperate to perform one or more of the processes and functionalities associated with the disclosed embodiments.

Although FIG. 15 describes a certain number of entities and processing/computing components within system environment 1500, any number or combination of components may be implemented without departing from the scope of the disclosed embodiments. For example, in some embodiments more than one third party system 1540 may be implemented. One skilled in the art will appreciate that the entities as described are not limited to their discrete descriptions above. Further, within system environment 1500 the computing and processing devices and software executed by these components may be integrated into a local or distributed system. For example, the internal memory 114 of each of key duplication machines 110a-110n may be configured to store software instructions that when executed by the computing system may perform one or more functions relating to the combined components in a manner consistent with the disclosed embodiments.

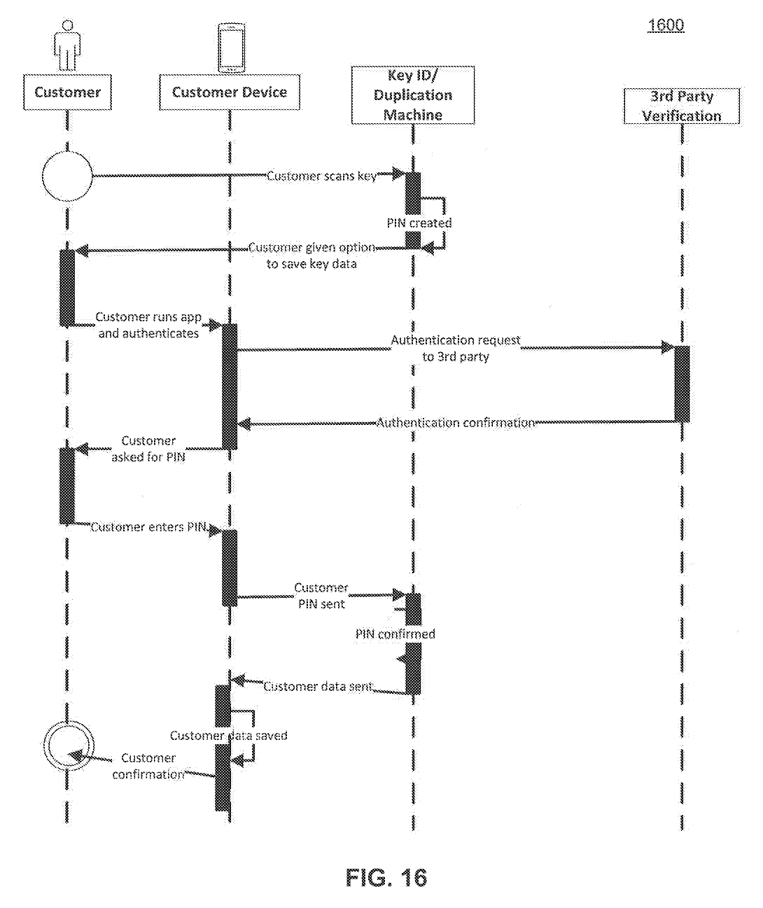

FIG. 16 is a flowchart of an exemplary device-controlled third party key data storage process 1600, consistent with example embodiments disclosed herein. FIG. 16 will be described in connection with the components described above illustrated in FIG. 15 as being associated with system environment 1500, but it is understood that other configurations are possible.

In one embodiment, a user 1510 may approach any particular key duplication machine from among key duplication machines 110a-110n seeking to duplicate a master key and/or to save data associated with such a key for future duplications. This process may be similar to that described above in association with FIGS. 3, 6, 11, and 12 and processes 300, 600, 1100, and 1200. At any time during the duplication/storage process, user 1510 may be asked by key duplication machine 110 (such as via a user interface or touchscreen associated with I/O devices 116) if they wish to store the key data determined by key identification module 120. If user 1510 opts to save the data, key duplication machine 110, via processor device 112, may generate a first secure code, or personal identification number (PIN). The code may be generated based on a random number generator, or by other known methods. In some embodiments, the first PIN may be immediately displayed to user 1510 on key duplication machine 110. In other embodiments, the first PIN may not be displayed to user 1510 unless user 1510 takes an affirmative action indicating that they wish to store their key data.

If user 1510 opts to store the data, key duplication machine 110 may prompt the user to authenticate their identity via a proprietary mobile application accessible by user device 1520. In these embodiments, the proprietary mobile application may be associated with and/or managed by the same entity that is associated with and/or manages key duplication machine 110. User device 1520 may already be configured to access the proprietary mobile application, or the mobile application may be accessible on the web via network 1530. Alternatively, user 1510 may be guided in downloading the proprietary mobile application onto user device 1520.

Upon opening the proprietary mobile application, user 1510 may be prompted by the mobile application for information that may be utilized to identify user 1510. In some embodiments, this information may include a username, password, or other such login credential associated with user 1510 for a third party service associated with third party system 1540. In some embodiments, user 1510 may have the option of automatically linking the proprietary key duplication mobile application with data and information associated with the third party service, and thus may not be required to enter identifying information again. In these embodiments, user 1510 may be required to have a mobile application associated with the third party service also available and/or open on user device 1520.

Upon receiving or accessing the third party identification information associated with user 1510, the proprietary mobile application associated with user device 1520 may initiate a data storage process. Via network 1530, the mobile application may send a request to third party system 1540 seeking to verify user 1510's identity. Third party system 1540 may verify and confirm user 1510's identity based on the submitted third party user credentials.

If the submitted third party user credentials match a set of credentials stored within third party system 1540 associated with user 1510, third party system 1540 may transmit a communication to user device 1520 and/or a computer system associated with the proprietary mobile application indicating that user 1510's identity has been verified.

In some embodiments, the communication may include a personalized software object, or token, comprising an application programming interface. Third party system 1540 may populate the software object with information associated with user 1510. Any or all of key duplication machine 110, user device 1520, third party system 1540, and/or a computer system associated with the proprietary mobile application may store the token in memory (such as memory devices 114) or on a separate associated external server. Additionally, security may be configured for the token to protect the privacy and fidelity of user 1510's identification information and key data.

The communication may be transmitted directly through the mobile application. In other embodiments, the communication may be sent to a telephone number or device address associated with user device 1520 previously input into key duplication machine 110 by user 1510. Alternatively, if the submitted third party user credentials do not match a set of credentials stored within third party server 1540 associated with user 1510, third party system 1540 may transmit a communication to user device 1520 and/or a computer system associated with the proprietary mobile application indicating that the key data cannot be stored due to an inability to verify the identity of user 1510. In these embodiments, user 1510 may be prompted to choose another method of verifying their identity; for example, the process described above in association with FIG. 3 and process 300, FIG. 11 and process 1100, or FIG. 12 and process 1200. The communications are optimally transmitted within a period of several seconds up to several minutes from the time that user 1510 indicated via key duplication machine 110 that they wished to store key data.

Upon confirmation of user 1510's identity, the proprietary mobile application may prompt user 1510 via user device 1520 to enter the first PIN previously displayed on key duplication machine 110 via I/O devices 116. This process enhances security by ensuring that user 1510, user device 1520, and key duplication machine 110 are all in the same physical location. In alternative embodiments (not shown) the PIN procedure may be skipped if both user device 1520 and key duplication machine 110 are equipped for NFC transmission and reception as discussed above.

If user 1510 wishes to continue with the data storage process at that time, user 1510 may proceed to enter the first PIN into user device 1520 via the proprietary mobile application for verification. In other embodiments, the PIN (or other identifying data) may be submitted via user device 1520 via email, SMS/text messaging, or near-field communication (NFC). Alternatively, if user 1510 declines to proceed, the first PIN may not be submitted. In these alternative embodiments, system 1500 may be configured to set a time within which the first PIN may expire. The configured expiration time may be on the order of minutes, hours, days, weeks, etc. The first PIN may be configured to expire for security reasons and to keep the data storage process within the full control of user 1510. Should the first PIN expire, user 1510 may initiate the data storage process again upon a future visit to a key duplication machine 110a-110n.

If user 1510 does choose to proceed, and enters a PIN into user device 1520 through a mobile application, text message, or other electronic message, user device 1520 may transmit the entered PIN to key duplication machine 110 via network 1530. Key duplication machine 110 may receive the transmitted PIN via communication interface 118, and may compare it to the first PIN previously displayed to user 1510. If the PIN received from user device 1520 does not match the displayed first PIN, key duplication machine 110 may display a notification via I/O devices 116 that the entered PIN number was incorrect. Alternatively, system 1500 may be configured such that key duplication machine 110 transmits the “incorrect PIN” communication directly to user 1510 via user device 1520, such as through the proprietary mobile application or via an email or SMS/text message.

If the PIN received does match the displayed first PIN, key duplication machine 110 may confirm user 1510's identity (for example, via the token configured by third party system 1540). Key duplication machine 110 may receive the message from third party system 1540 via communication interface 118, and may be configured to display a message to user 1510 via I/O device 116 that the PIN entered by user 1510 was correct. Key duplication machine 110 may proceed to encrypt, via processor device 112, the determined key blank information and bitting pattern information associated with any or all master keys presented for duplication at key duplication machine 110 by user 1510. Key duplication machine 110 may further add additional information to the encrypted data. The additional information may include, but not be limited to, the first PIN generated by key duplication machine 110, the telephone number or device address associated with user device 1520, information associated with a mobile application and with user 1510, information associated with a third-party service and with user 1510, such as an account associated with a cloud-based service or social media service, the date that the key data was originally stored, the location where the key data was originally stored, a user “label” for the key such as a name or description, etc.

Key duplication machine 110 may proceed to transmit the encrypted data (with embedded additional information) to user device 1520, where it may be securely stored. The transmission may be effected by NFC or by any of the other means of transmission via network 1530 described above. Depending on the embodiment, user device 1520 may be configured to store the encrypted key data on a local memory device. In other embodiments, user device 1520 may be configured to store the encrypted key data via cloud-based storage associated with the manufacturer of user device 1050 and/or a service provider of user device 1520, such as a wireless carrier (which may use the same third party system 1540 as described above, or a different third party system). User 1510 may confirm receipt and storage of the data through user device 1520, such as through a mobile application or by a return SMS/text message or email.

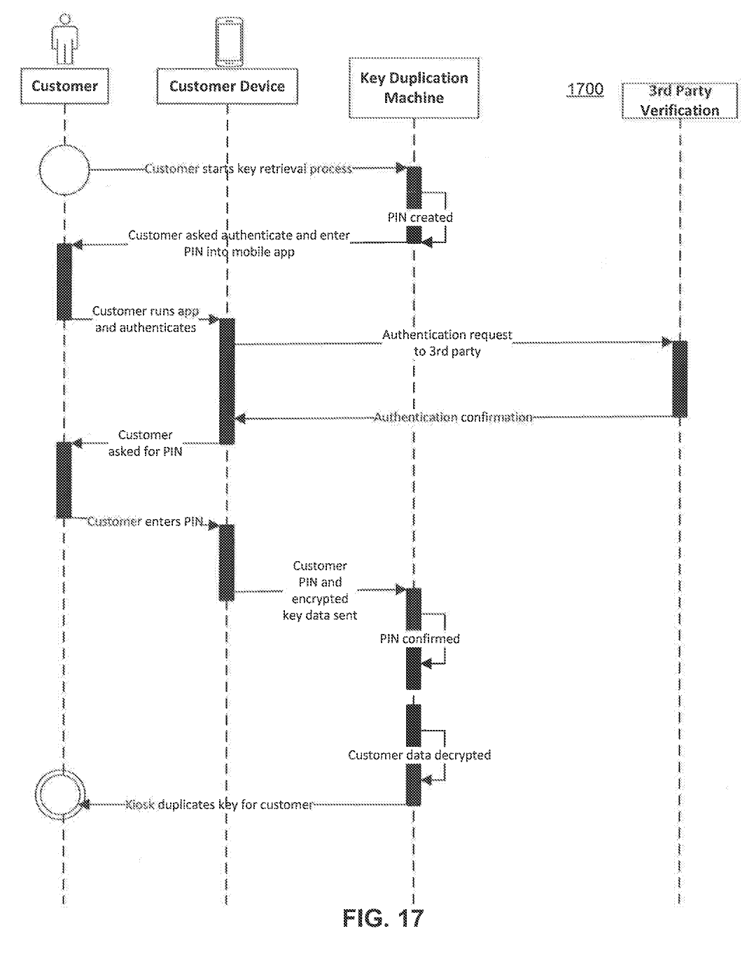

FIG. 17 is a flowchart of an exemplary device-controlled third party key data retrieval process 1700, consistent with example embodiments disclosed herein. FIG. 17 will be described in connection with the components described above illustrated in FIG. 15 as being associated with system environment 1500, but it is understood that other configurations are possible.

In one embodiment, a user 1510 may approach any particular key duplication machine from among key duplication machines 110a-110n seeking to duplicate a master key and/or to save data associated with such a key for future duplications. This process may be similar to that described above in association with FIGS. 4 and 7 and processes 400 and 700. User 1510 may indicate to key duplication machine 110 that they wish to retrieve previously-stored key data via one or more inputs to key duplication machine 110 via I/O devices 116. Upon receiving such an input, key duplication machine 110, via processor device 112, may generate a second secure code, or personal identification number (PIN). The code may be generated based on a random number generator, or by other known methods. In some embodiments, the second PIN may be different from the first PIN (described in association with FIG. 16 and process 1600 above) generated when user 1510 stored the key data previously. In other embodiments, the first and second PINs may be the same.

If user 1510 opts to retrieve previously-stored key data, key duplication machine 110 may prompt the user to authenticate their identity via a proprietary mobile application accessible by user device 1520. In these embodiments, the proprietary mobile application may be associated with and/or managed by the same entity that is associated with and/or manages key duplication machine 110. User device 1520 may already be configured to access the proprietary mobile application, or the mobile application may be accessible on the web via network 1530. Alternatively, user 1510 may be guided in downloading the proprietary mobile application onto user device 1520.

Upon opening the proprietary mobile application, user 1510 may be prompted by the mobile application for information that may be utilized to identify user 1510. In some embodiments, this information may include a username, password, or other such login credential associated with user 1510 for a third party service associated with third party system 1540. In some embodiments, user 1510 may have the option of automatically linking the proprietary key duplication mobile application with data and information associated with the third party service, and thus may not be required to enter identifying information again. In these embodiments, user 1510 may be required to have a mobile application associated with the third party service also available and/or open on user device 1520.

Upon receiving or accessing the third party identification information associated with user 1510, the proprietary mobile application associated with user device 1520 may initiate a data retrieval process. Via network 1530, the mobile application may send a request to third party system 1540 seeking to verify user 1510's identity. Third party system 1540 may verify and confirm user 1510's identity based on the submitted third party user credentials.

If the submitted third party user credentials match a set of credentials stored within third party system 1540 associated with user 1510, third party system 1540 may transmit a communication to user device 1520 and/or a computer system associated with the proprietary mobile application and/or key duplication machine 110 indicating that user 1510's identity has been verified.

In some embodiments, the communication may include a personalized software object, or token, comprising an application programming interface. Third party system 1540 may populate the software object with information associated with user 1510. Any or all of key duplication machine 110, user device 1520, third party system 1540, and/or a computer system associated with the proprietary mobile application may store the token in memory (such as memory devices 114) or on a separate associated external server. Additionally, security may be configured for the token to protect the privacy and fidelity of user 1510's identification information and key data.

The communication may be transmitted directly through the mobile application. In other embodiments, the communication may be sent to a telephone number or device address associated with user device 1520 previously input into key duplication machine 110 by user 1510. Alternatively, if the submitted third party user credentials do not match a set of credentials stored within third party server 1540 associated with user 1510, third party system 1540 may transmit a communication to user device 1520 and/or a computer system associated with the proprietary mobile application indicating that the key data cannot be retrieved due to an inability to verify the identity of user 1510. In these embodiments, user 1510 may be prompted to choose another method of verifying their identity; for example, the process described above in association with FIG. 4 and process 400. The communications are optimally transmitted within a period of several seconds up to several minutes from the time that user 1510 indicated via key duplication machine 110 that they wished to retrieve previously-stored key data.

Upon confirmation of user 1510's identity, the proprietary mobile application may prompt user 1510 via user device 1520 to enter the second PIN previously displayed on key duplication machine. This process enhances security by ensuring that user 1510, user device 1520, and key duplication machine 110 are all in the same physical location. In alternative embodiments (not shown) the PIN procedure may be skipped if both user device 1520 and key duplication machine 110 are equipped for NFC transmission and reception as discussed above.

If user 1510 wishes to continue with the data retrieval process at that time, user 1510 may proceed to enter the second PIN into user device 1520 via the proprietary mobile application for verification. Alternatively, if user 1510 declines to proceed, the second PIN may not be submitted. In these alternative embodiments, system 1500 may be configured to set a time within which the second PIN may expire. The configured expiration time may be on the order of minutes, hours, days, weeks, etc. The second PIN may be configured to expire for security reasons and to keep the data retrieval process within the full control of user 1510. Should the second PIN expire, user 1510 may initiate the data retrieval process again upon a future visit to a key duplication machine 110a-110n.

If user 1510 does choose to proceed, and enters a PIN into user device 1520, user device 1520 may transmit the entered PIN to key duplication machine 110 via network 1530. Key duplication machine 110 may receive the transmitted PIN via communication interface 118, and may compare it to the second PIN previously displayed to user 1510. If the PIN received from user device 1520 does not match the displayed second PIN, key duplication machine 110 may display a notification via I/O devices 116 that the entered PIN number was incorrect. Alternatively, system 1500 may be configured such that key duplication machine 110 transmits the “incorrect PIN” communication directly to user 1510 via user device 1520, such as through the proprietary mobile application.

If the PIN received does match the displayed second PIN, key duplication machine 110 may confirm user 1510's identity (for example, via the token configured by third party system 1540) and may request retrieval of previously stored key data from user device 1520 via network 1530. Alternatively, the data may already have been transmitted by user 1510 from user device 1520.

Key duplication machine 110 may be configured to receive the stored key data via communication interface 118, and via processor device 112 and key cutting module 122, may duplicate a key for user 1510 based on the stored and retrieved key data. The key duplication process may proceed substantially as described above. Upon completion of the cutting of the key, key duplication machine 110 may provide the duplicated key to user 1510.

The data retrieval processes described above, including processes 400, 700, 900, 1300, 1400, and 1700, may each alternatively be configured in a manner such that user 210, user 510, user 1010, or user 1510 need not be physically present at a key duplication machine 110 in order to retrieve key data and have a key cut in accordance with the retrieved data. For example, user 210, user 510, user 1010, or user 1510 may be able to request a key be cut in accordance with previously-stored key data via a proprietary mobile application or a web interface via user device 220, 520, 1020, or 1520. The entity associated with the mobile application and/or key duplication machines 110a-110n may cut such a key at a remote location, then ship it to user 210, user 510, user 1010, or user 1510 at a mailing address indicated by the user.

As configured, the systems, apparatuses, and methods contemplated by the disclosed embodiments allow consumers to duplicate keys in a more secure, convenient, and efficient manner than ever before. The systems and methods described herein take full advantage of digital technology, allowing secure identification verification via mobile applications and third party systems, such as social media sites. For retail establishments, the disclosed systems and methods permit cutting of keys (traditionally a frustrating, unprofitable process) with minimal inputs of labor, training, and inventory management. For the user, keys can be duplicated without needing to have the master key in hand—a huge advantage, for example, if said key has been lost or damaged. The disclosed embodiments are more secure than prior art systems and methods because they utilize security codes (PINs) randomly generated by an entity other than the user. The user is at lower risk for a security breach that could provide access to their home or office, since the embodiments permit storage and retrieval of key data without relying on user-generated usernames and passwords.

Other embodiments consistent with the disclosure will be apparent to those skilled in the art from consideration of the specification and practice of the embodiments disclosed herein. It is intended that the specification and examples be considered as examples only, with a true scope and spirit of the disclosed embodiments being indicated by the following claims.

What is claimed is:

1. A system comprising:
one or more kiosks, each kiosk comprising one or more processor devices, and a key identification module,
wherein the one or more processor devices associated with the one or more kiosks are configured to:
receive a request from a user to store key information determined by the key identification module;
verify the identity of the user;
encrypt the key information; and
transmit the encrypted key information and information associated with the identity of the user to a remote device associated with the user.

2. The system of claim 1, wherein verifying the identity of the user further comprises confirmation of a security code.

3. The system of claim 1, wherein verifying the identity of the user further comprises receiving a transmission from the remote device associated with the user via wireless communication.

4. The system of claim 3, wherein wireless communication further comprises one or more of cellular, WiFi, Bluetooth, or near-field communication.

5. The system of claim 1, wherein verifying the identity of the user further comprises receiving a transmission via a wired Internet connection or DSL.

6. The system of claim 1, wherein verifying the identity of the user further comprises confirmation of the user's identity via a computer system associated with a third party.

7. The system of claim 6, wherein the third party is a social media entity.

8. The system of claim 6, wherein the one or more processor devices associated with the one or more kiosks are further configured to:
prompt the user to enter credentials associated with the third party computer system;
receive input of user credentials;
transmit the received user credentials to the third party computer system;
receive a communication from the third party computer system indicating that the inputted user credentials match user credentials associated with the user stored on the third party computer system; and
transmit a communication to the one or more kiosks indicating that the user's identity has been verified by the third party computer system.

9. A system comprising:
one or more kiosks, each kiosk comprising one or more processor devices, a key identification module and a key cutting module,
wherein the one or more processor devices associated with the one or more kiosks are configured to:
receive a request from a user to retrieve previously stored key information associated with the user;
verify the identity of the user;
receive a communication from a remote device associated with the user comprising the previously stored key information in an encrypted form;
decrypt the previously stored key information;
determine, via the key identification module, a key blank associated with the decrypted key information;
cut, via the key cutting module, the key blank based at least on the decrypted key information; and
provide the cut key blank to the user.

10. The system of claim 9, wherein verifying the identity of the user further comprises confirmation of a security code.

11. The system of claim 9, wherein verifying the identity of the user further comprises receiving a transmission from the remote device associated with the user via wireless communication.

12. The system of claim 11, wherein wireless communication further comprises one or more of cellular, WiFi, Bluetooth, or near-field communication.

13. The system of claim 9, wherein verifying the identity of the user further comprises receiving a transmission via a wired Internet connection or DSL.

14. The system of claim 9, wherein verifying the identity of the user further comprises confirmation of the user's identity via a computer system associated with a third party.

15. The system of claim 14, wherein the third party is a social media entity.

16. The system of claim 14, wherein the one or more processor devices associated with the one or more kiosks are further configured to:
prompt the user to enter credentials associated with the third party computer system;
receive input of user credentials;
transmit the received user credentials to the third party computer system;
receive a communication from the third party computer system indicating that the inputted user credentials match user credentials associated with the user stored on the third party computer system; and
transmit a communication to the one or more kiosks indicating that the user's identity has been verified by the third party computer system.

17. The system of claim 14, wherein the one or more processor devices associated with the one or more kiosks are further configured to:
generate second security information in response to a user request to retrieve key data,
wherein the second security information is different from first security information generated when the key data was originally stored;
transmit the generated second security information to a computer system associated with a mobile application;
receive security information inputted by the user via the mobile application;
receive a communication from the computer system associated with the mobile application indicating that the user's identity has been verified by the third party computer system; and
transmit a communication to the one or more kiosks providing instructions for retrieving the key data associated with the user.

18. A method for storing key data via one or more kiosks comprising one or more processor devices, and a key identification module, comprising:
receiving a request from a user to store key information determined by the key identification module;
verifying the identity of the user;
encrypting the key information; and
transmitting the encrypted key information and information associated with the identity of the user to a remote device associated with the user.

19. The method of claim 18, wherein verifying the identity of the user further comprises confirmation of a security code.

20. The method of claim 18, wherein verifying the identity of the user further comprises receiving a transmission from the remote device associated with the user via wireless communication.

21. The method of claim 20, wherein wireless communication further comprises one or more of cellular, WiFi, Bluetooth, or near-field communication.

22. The method of claim 18, wherein verifying the identity of the user further comprises receiving a transmission via a wired Internet connection or DSL.

23. A method for retrieving key data via one or more kiosks comprising one or more processor devices, a key identification module and a key cutting module, comprising:
receiving a request from a user to retrieve previously stored key information associated with the user;
verifying the identity of the user;
receiving a communication from a remote device associated with the user comprising the previously stored key information in an encrypted form;
decrypting the previously stored key information;
determining, via the key identification module, a key blank associated with the decrypted key information;
cutting, via the key cutting module, the key blank based at least on the decrypted key information; and
providing the cut key blank to the user.

24. The method of claim 23, wherein verifying the identity of the user further comprises confirmation of a security code.

25. The method of claim 23, wherein verifying the identity of the user further comprises receiving a transmission from the remote device associated with the user via wireless communication.

26. The method of claim 25, wherein wireless communication further comprises one or more of cellular, WiFi, Bluetooth, or near-field communication.

27. The method of claim 23, wherein verifying the identity of the user further comprises receiving a transmission via a wired Internet connection or DSL.

28. The method of claim 23, wherein verifying the identity of the user further comprises confirmation of the user's identity via a computer system associated with a third party.
